(19) United States
(12) Patent Application Publication
(10) Pub. No.: US 2011/0113318 A1
(43) Pub. Date: May 12, 2011

(54) INFORMATION PROCESSING DEVICE, METHOD, AND COMPUTER-READABLE RECORDING MEDIUM RECORDING PROGRAM

(76) Inventors: Masashi Hirosawa, Osaka (JP); Masaya Nakamura, Osaka (JP); Atsushi Kanno, Osaka (JP)

(21) Appl. No.: 12/991,369

(22) PCT Filed: Mar. 30, 2009
(86) PCT No.: PCT/JP2009/056457

§ 371 Date: Nov. 5, 2010

(30) Foreign Application Priority Data
May 8, 2008 (JP) 2008-122526

(51) Int. Cl. G06F 17/21; G09G 5/00; G09G 5/02

(52) U.S. Cl. 715/207; 345/581; 345/589

(57) ABSTRACT

An information processing device includes a display, an access unit for accessing a storage medium, and a display control unit referring to the storage medium and causing the display to display text. The storage medium stores at least one text data. Each of the text data includes at least one text for which a display attribute value is set. In a first mode, the display control unit causes the text to be displayed within a first display area of the display in a display manner in accordance with an associated display attribute value. In a second mode, the display control unit causes the text to be displayed within a second display area smaller than the first display area of the display in a predetermined display manner independent of the associated display attribute value.

### TECHNICAL FIELD

The present invention relates to an information processing device, a text display program, and a text display method causing a display to display text based on text data, and in particular to an information processing device, a text display program, and a text display method changing a display manner of text for each mode based on a plurality of display attributes.

### BACKGROUND ART

Information processing devices such as an electronic dictionary and a mobile phone receive input of a character string from a user via a keyboard, a touch panel, and the like. Based on the input character string, the information processing devices display a sentence and the like corresponding to the character string. Some of such information processing devices display a detailed sentence corresponding to a character string input in a first area of a display or a character string being selected in a first mode, and display a portion of the detailed sentence in an area smaller than the first area of the display in a second mode (a word selection mode or a preview mode).

Therefore, techniques of providing a device user with more information at once by processing data to be displayed into data in a display format in accordance with the size of a screen of an output device have been proposed.

For example, Japanese Patent Laying-Open No. 5-290047 (Patent Document 1) discloses a data processing/displaying device. According to Japanese Patent Laying-Open No. 5-290047 (Patent Document 1), the data processing/displaying device includes input means implemented by a keyboard, a storage unit for display data, reading means for stored display data, processing means for read data, and display means displaying processed data. The data processing/displaying device displays data in accordance with the size of a display screen.

In addition, Japanese Patent Laying-Open No. 2005-267449 (Patent Document 2) discloses a data processing method. According to Japanese Patent Laying-Open No. 2005-267449 (Patent Document 2), influence detection means detects whether or not a processing result of partial data on the periphery of desired partial data exerts influence by division on a processing result of the desired partial data. If influence is exerted, layout generation means processes data from the partial data to the desired partial data as continuous data. Further, whether partial data to be processed in advance is not influenced by peripheral partial data is also detected. If the partial data is influenced, the partial data and the influencing partial data are processed as continuous data.

These processes are repeated until no influence is detected.

### Patent Document 1 : Japanese Patent Laying-Open No. 5-290047

### Patent Document 2 : Japanese Patent Laying-Open No. 2005-267449

### DISCLOSURE OF THE INVENTION

### Problems to be Solved by the Invention

However, conventional information processing devices always perform the same data processing to cause a display to display as many characters as possible. For example, the conventional information processing devices always display text with no line break irrespective of mode.

Therefore, the conventional information processing devices cannot deal with the case where the same display displays text in different layouts (layouts in different modes). For example, in an information processing device displaying text in display areas having different sizes and shapes in accordance with the type and item of a character string to be displayed, preferable display manners vary depending on the sizes and the shapes of the display areas, the numbers of characters to be displayed in the display areas, and the like.

More specifically, even when a sentence indicating the same content is displayed, if the display area has a large size, it is preferable to give priority to improving a user's visibility by using a large font, utilizing a line break, and attaching an image. In contrast, if the display area has a small size, it is preferable to give priority to displaying more text.

The present invention has been made to solve the aforementioned problem, and a main object of the present invention is to provide an information processing device, a text display program, and a text display method capable of displaying text having the same content in a more appropriate display manner for each display area or for each display mode.

### Means for Solving the Problems

According to an aspect of the present invention, an information processing device includes a display, and an access unit for accessing a storage medium. The storage medium stores at least one text data, and each of the text data includes at least one text for which a display attribute value is set. The information processing device further includes a display control unit referring to the storage medium and causing the display to display the text. In a first mode, the display control unit causes the text to be displayed within a first display area of the display in a display manner in accordance with an associated display attribute value. In a second mode, the display control unit causes the text to be displayed within a second display area smaller than the first display area of the display in a predetermined display manner independent of the associated display attribute value.

Preferably, the information processing device further includes a manipulation unit receiving first and second instructions for designating a display state by the display. The display control unit shifts from the second mode to the first mode in accordance with the first instruction, and shifts from the first mode to the second mode in accordance with the second instruction.

Preferably, the storage medium further stores each word to associate it with the text data. In the second mode, the display control unit causes a plurality of the words to be selectably displayed as a list within a third display area of the display, and causes the text to be displayed in the second display area based on the text data associated with the word being selected. In the second mode, the manipulation unit receives an instruction to decide one word from the plurality of the words displayed as a list on the display as the first instruction.

Preferably, the information processing device further includes a search unit referring to the storage medium and searching for the words including an input character string. In the second mode, the display control unit causes the words as searched for to be selectably displayed as a list within the third display area.

Preferably, the display attribute value set for the text includes a first display attribute value included in a first display attribute value group. The predetermined display attribute value includes a second display attribute value included in the first display attribute value group. The first display attribute group is a font size group. The first display attribute value is a font size set for the text. The second display attribute value is a predetermined font size.

Preferably, the display control unit includes a determination unit determining whether or not the first display attribute value is not less than the second display attribute value. If the first display attribute value is not less than the second display attribute value in the second mode, the display control unit causes the display to display the text based on the second display attribute value. If the first display attribute value is less than the second display attribute value in the second mode, the display control unit causes the display to display the text based on the first display attribute value.

Preferably, the display attribute value set for the text includes a third display attribute value included in a second display attribute value group. A predetermined display attribute value includes a fourth display attribute value included in the second display attribute value group. The second display attribute group is a color group. The third display attribute value is a color set for the text. The fourth display attribute value is a predetermined color.

The text data includes line break designation for displaying the text with a line break. In the first mode, the display control unit refers to the text data, and causes the display to display the text with a line break based on the line break designation. In the second mode, the display control unit refers to the text data, and causes the display to display the text with no line break.

Preferably, the storage medium further stores image data to associate it with the text data. In the first mode, the display control unit causes the display to display the text and image based on the text data and the image data. In the second mode, the display control unit causes the display to display the text based on the text data without displaying the image.

Preferably, the storage medium further stores image data to associate it with the text data. In the first mode, the display control unit causes the display to display the text and image based on the text data and the image data. In the second mode, the display control unit causes the display to display the text and the image as reduced based on the text data and the image data.

Preferably, the text data includes text for which a change attribute value to temporally change the display manner is set. In the first mode, the display control unit refers to the text data, and causes the display to display the associated text while changing the display manner based on the change attribute value. In the second mode, the display control unit does not cause the display to display the associated text.

Preferably, the text data includes text for which a change attribute value to temporally change the display manner is set. In the first mode, the display control unit refers to the text data, and causes the display to display the associated text while changing the display manner based on the change attribute value. In the second mode, the display control unit refers to the text data, and causes the display to display the associated text without changing the display manner.

Preferably, the text data includes text for which a link attribute value indicating that a link is provided is set. In the first mode, the display control unit refers to the text data, and causes the display to selectably display the associated text in a display manner different from that of other text based on the link attribute. In the second mode, the display control unit refers to the text data, and causes the display to unselectably display the associated text in a display form identical to that of other text.

Preferably, the storage medium is an external storage medium that is attachable to and removable from the information processing device.

Preferably, the information processing device further includes the storage medium therein.

According to another aspect of the present invention, a text display method in an information processing device including a display and a computation processing unit is provided. The text display method includes the steps of: reading text data including at least one text for which a display attribute value is set, by the computation processing unit; causing the text to be displayed within a first display area of the display in a display manner in accordance with an associated display attribute value, by the computation processing unit, in a first mode; and causing the text to be displayed within a second display area smaller than the first display area of the display in a predetermined display manner independent of the associated display attribute value, by the computation processing unit, in a second mode.

According to another aspect of the present invention, a computer-readable recording medium recording a text display program for causing an information processing device including a display and a computation processing unit to display text is provided. The text display program causes the computation processing unit to perform the steps of: reading text data including at least one text for which a display attribute value is set; causing the text to be displayed within a first display area of the display in a display manner in accordance with an associated display attribute value in a first mode; and causing the text to be displayed within a second display area smaller than the first display area of the display in a predetermined display manner independent of the associated display attribute value in a second mode.

### EFFECTS OF THE INVENTION

As described above, according to the present invention, an information processing device, a text display program, and a text display method capable of displaying text having the same content in a more appropriate display manner for each display area or for each display mode are provided.

### BRIEF DESCRIPTION OF THE DRAWINGS

FIG. 1 is a schematic perspective view showing an electronic dictionary 100 for a first language having a horizontally long display as an example of an information processing device.

FIG. 2 is a schematic perspective view showing electronic dictionary 100 for a second language having a horizontally long display as an example of the information processing device.

FIG. 3 shows a first schematic diagram showing the display of the electronic dictionary for the first language in a second mode and a second schematic diagram showing the display of the electronic dictionary for the first language in a first mode.

FIG. 4 shows a first schematic diagram showing the display of the electronic dictionary for the second language in a second mode and a second schematic diagram showing the display of the electronic dictionary for the second language in a first mode.

FIG. 5 shows a second schematic diagram showing the display of the electronic dictionary for the first language in the second mode and a second schematic diagram showing the display of the electronic dictionary for the first language in the first mode.

FIG. 6 shows a second schematic diagram showing the display of the electronic dictionary for the second language in the second mode and a second schematic diagram showing the display of the electronic dictionary for the second language in the first mode.

FIG. 7 is a schematic perspective view showing a mobile phone having a vertically long display as an example of an information processing device.

FIG. 8 shows a first schematic diagram showing the display of the mobile phone for the first language in a second mode and a second schematic diagram showing the display of the mobile phone for the first language in a first mode.

FIG. 9 shows a first schematic diagram showing the display of the mobile phone for the second language in a second mode and a second schematic diagram showing the display of the mobile phone for the second language in a first mode.

FIG. 10 shows a second schematic diagram showing the display of the mobile phone for the first language in the second mode and a second schematic diagram showing the display of the mobile phone for the first language in the first mode.

FIG. 11 shows a second schematic diagram showing the display of the mobile phone for the second language in the second mode and a second schematic diagram showing the display of the mobile phone for the second language in the first mode.

FIG. 12 shows a schematic diagram showing a screen displayed in a detailed area X of the display and a schematic diagram showing a screen displayed in a preview area Y of the display.

FIG. 13 is a control block diagram showing a hardware configuration of the electronic dictionary as an example of an information processing device in accordance with the present embodiment.

FIG. 14 is a control block diagram showing a hardware configuration of the mobile phone as an example of the information processing device in accordance with the present embodiment.

FIG. 15 is a block diagram showing a functional configuration of the information processing device in accordance with the present embodiment.

FIG. 16 is a schematic diagram showing text data for displaying a sentence for explaining one word.

FIG. 17 is a schematic diagram showing an exemplary data structure of element data serving as a basic unit of display layout.

FIG. 18 is a schematic diagram showing an exemplary data structure of line data for managing a collection of elements.

FIG. 19 shows a first schematic diagram showing the display for the first language in the second mode in accordance with the present embodiment and a first schematic diagram showing the display for the first language in the first mode in accordance with the present embodiment.

FIG. 20 shows a first schematic diagram showing the display for the second language in the second mode in accordance with the present embodiment and a first schematic diagram showing the display for the second language in the first mode in accordance with the present embodiment.

FIG. 21 shows a second schematic diagram showing the display for the first language in the second mode in accordance with the present embodiment and a second schematic diagram showing the display for the first language in the first mode in accordance with the present embodiment.

FIG. 22 shows a second schematic diagram showing the display for the second language in the second mode in accordance with the present embodiment and a second schematic diagram showing the display for the second language in the first mode in accordance with the present embodiment.

FIG. 23 shows a third schematic diagram showing the display in the second mode in accordance with the present embodiment and a third schematic diagram showing the display in the first mode in accordance with the present embodiment.

FIG. 24 shows a fourth schematic diagram showing the display for the first language in the second mode in accordance with the present embodiment and a fourth schematic diagram showing the display for the first language in the first mode in accordance with the present embodiment.

FIG. 25 shows a fourth schematic diagram showing the display for the second language in the second mode in accordance with the present embodiment and a fourth schematic diagram showing the display for the second language in the first mode in accordance with the present embodiment.

FIG. 26 shows a fifth schematic diagram showing the display in the second mode in accordance with the present embodiment and a fifth schematic diagram showing the display in the first mode in accordance with the present embodiment.

FIG. 27 shows a sixth schematic diagram showing the display in the second mode in accordance with the present embodiment and a sixth schematic diagram showing the display in the first mode in accordance with the present embodiment.

FIG. 28 shows a seventh schematic diagram showing the display for the first language in the second mode in accordance with the present embodiment and a seventh schematic diagram showing the display for the first language in the first mode in accordance with the present embodiment.

FIG. 29 shows a seventh schematic diagram showing the display for the second language in the second mode in accordance with the present embodiment and a seventh schematic diagram showing the display for the second language in the first mode in accordance with the present embodiment.

FIG. 30 shows an eighth schematic diagram showing the display for the first language in the second mode in accordance with the present embodiment and an eighth schematic diagram showing the display for the first language in the first mode in accordance with the present embodiment.

FIG. 31 shows an eighth schematic diagram showing the display for the second language in the second mode in accordance with the present embodiment and an eighth schematic diagram showing the display for the second language in the first mode in accordance with the present embodiment.

FIG. 32 shows a ninth schematic diagram showing the display for the first language in the second mode in accordance with the present embodiment and a ninth schematic diagram showing the display for the first language in the first mode in accordance with the present embodiment.

FIG. 33 shows a ninth schematic diagram showing the display for the second language in the second mode in accordance with the present embodiment and a ninth schematic diagram showing the display for the second language in the first mode in accordance with the present embodiment.

FIG. 34 is a flowchart illustrating a processing procedure for text processing in the electronic dictionary in accordance with the present embodiment.

FIG. 35 is a flowchart illustrating a processing procedure for start processing in the electronic dictionary in accordance with the present embodiment.

FIG. 36 is a flowchart illustrating a processing procedure for content processing in the electronic dictionary in accordance with the present embodiment.

FIG. 37 is a flowchart illustrating a processing procedure for image processing in the electronic dictionary in accordance with the present embodiment.

FIG. 38 is a flowchart illustrating a processing procedure for ruby processing in the electronic dictionary in accordance with the present embodiment.

FIG. 39 is a flowchart illustrating a processing procedure for telop processing in the electronic dictionary in accordance with the present embodiment.

FIG. 40 is a flowchart illustrating a processing procedure for font processing in the electronic dictionary in accordance with the present embodiment.

FIG. 41 is a flowchart illustrating a processing procedure for link processing in the electronic dictionary in accordance with the present embodiment.

FIG. 42 is a flowchart illustrating a processing procedure for end processing in the electronic dictionary in accordance with the present embodiment.

FIG. 43 is a flowchart illustrating a processing procedure for text processing in the electronic dictionary in accordance with the present embodiment.

FIG. 44 is a schematic diagram showing text data for the preview area for displaying a sentence for explaining one word.

### DESCRIPTION OF THE REFERENCE SIGNS

10: network, 100: electronic dictionary, 101: communication device, 102: internal bus, 103: main storage medium, 103A: dictionary database, 103A-1: text data, 103B: element database, 103C: line database, 103E: image data, 103F: audio data, 103S: storage medium, 104: external storage medium, 106: CPU, 106A: computation processing unit, 106B: search unit, 106C: display control unit, 106D: audio control unit, 106G: obtaining unit, 106H: determination unit, 106R: reading unit, 107: display, 109: speaker, 111: mouse, 112: tablet, 113: buttons, 113A: manipulation unit, 114: keyboard, 200: mobile phone, 201: communication device, 202: internal bus, 203: main storage medium, 204: external storage medium, 206: CPU, 207: display, 209: speaker, 211: microphone, 212: camera, 213: buttons, 214: numerical keypad, X: detailed area, Y: preview area, Z: list area.

### BEST MODES FOR CARRYING OUT THE INVENTION

Hereinafter, embodiments of the present invention will be described with reference to the drawings. In the description below, identical parts will be designated by the same reference numerals, and if their names and functions are the same, the detailed description thereof will not be repeated.

### Embodiment 1

<Entire Configuration>

Firstly, an entire configuration of an information processing device in accordance with the present embodiment will be described. The information processing device in accordance with the present embodiment causes a display to display text based on text data stored in a storage medium. In particular, the information processing device can display text in different display manners based on a plurality of display attributes, using for example a browser function and the like. It is to be noted that the text data may be stored in a recording medium as binary data after being subjected to character code conversion, or in a compressed or encrypted state.

More specifically, the text data includes a display attribute designating a display manner of each text when each text is displayed, such as an HTML format and an XML format. The information processing device is typically implemented by an electronic dictionary, a PDA (Personal Digital Assistance), a mobile phone, a personal computer, a workstation, or the like. Further, data such as still image data, moving image data, audio data, and bibliographic data may be stored as separate files, or they may be archived into one file. It is to be noted that expressions such as “display of text (data)” and “display of a sentence” described hereinafter may include display or reproduction of various data such as still image data, moving image data, audio data, and bibliographic data designated in a content.

Then, the information processing device changes the size and the shape of a display area in which text is to be displayed, in accordance with the type and item of the text to be displayed. That is, the information processing device changes the display manner of the text to be displayed to a more appropriate display manner for each display area in each display mode. For example, the information processing device receives input of a character string from a user, displays words corresponding to the character string in a small display area as a list, and previews a portion of a sentence for explaining a word being selected in a small display area. Further, the information processing device displays a sentence for explaining a word decided by the user in a large display area. It is to be noted that the term “word” expressed in the present specification for explanation actually means “a character string including a word, a sentence, and the like”. In addition, the “sentence for explaining a word” displayed in another display area includes a “sentence related to a word”.

Text display processing performed by the information processing device as described above is implemented by a computation processing unit reading a text display program stored in a storage unit and executing the text display program.

<Operation Outline>

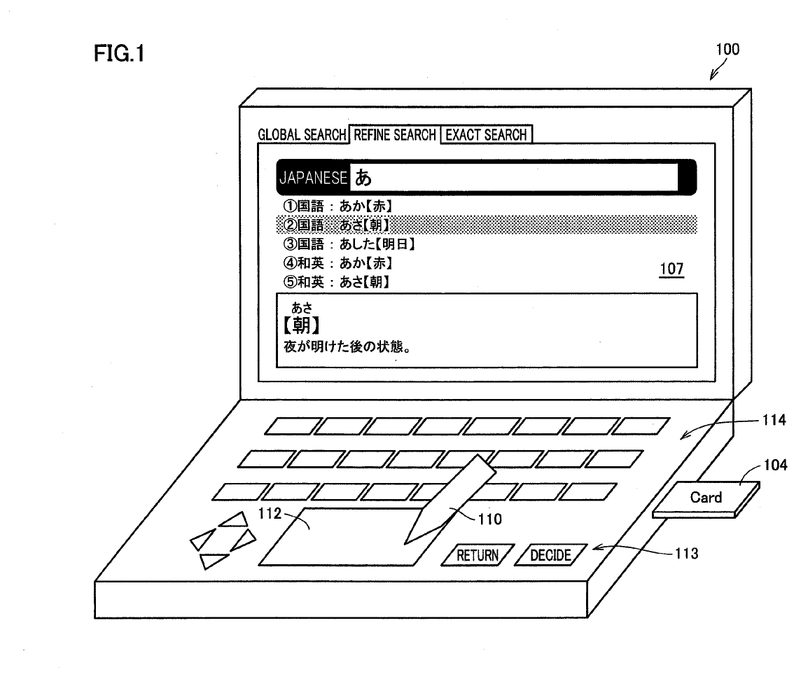

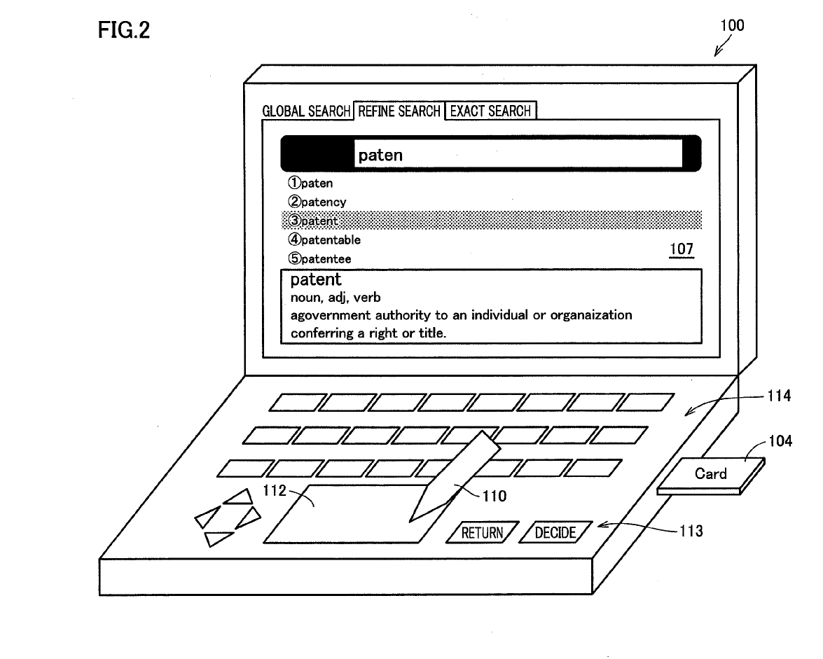

An operation outline in the information processing device in accordance with the present embodiment will be described. FIG. 1 is a schematic perspective view showing an electronic dictionary 100 for a first language (Japanese in the present embodiment) having a horizontally long display 107 as an example of the information processing device. FIG. 2 is a schematic perspective view showing electronic dictionary 100 for a second language (English in the present embodiment) having a horizontally long display as an example of the information processing device. As shown in FIGS. 1 and 2, electronic dictionary 100 causes horizontally long display 107 to display text based on text data. Electronic dictionary 100 receives input of a character string from a user via buttons 113 and a keyboard 114.

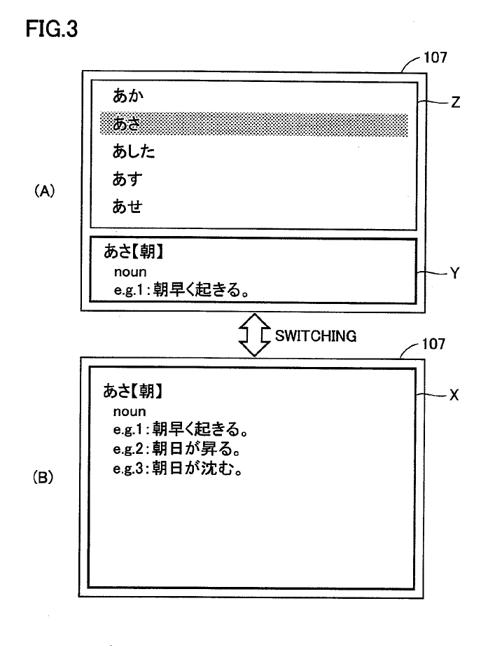

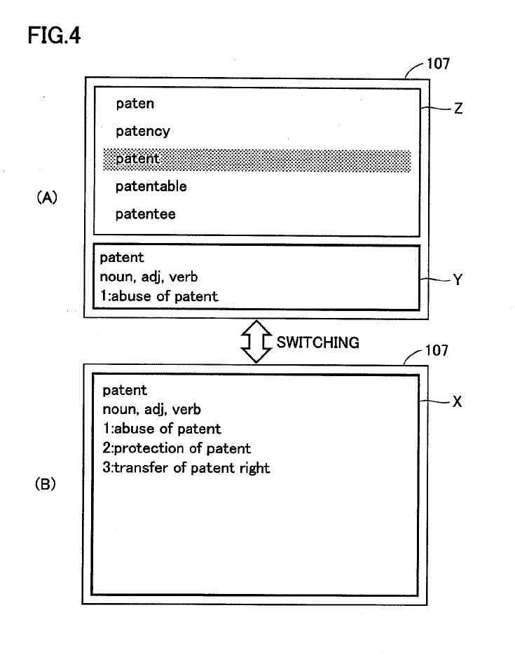

FIG. 3(A) is a first schematic diagram showing display 107 of electronic dictionary 100 for the first language in a second mode. FIG. 3(B) is a second schematic diagram showing display 107 of electronic dictionary 100 for the first language in a first mode. FIG. 4(A) is a first schematic diagram showing display 107 of electronic dictionary 100 for the second language in a second mode. FIG. 4(B) is a second schematic diagram showing display 107 of electronic dictionary 100 for the second language in a first mode. FIGS. 3 and 4 are schematic diagrams showing the state where display 107 displays information about the dictionary on an entire surface thereof.

However, the present invention is not limited to such a display form, and electronic dictionary 100 may perform display based on another layout. For example, a screen (an area) is not necessarily divided into upper and lower portions. That is, the screen (area) may be divided into right and left portions, and a pop-up screen may be displayed. Since menu display, a character input unit, and the like are identical to those in FIGS. 1 and 2, the description thereof will not be repeated here.

As shown in FIGS. 3(A) and 4(A), display 107 selectably displays a plurality of words corresponding to an input character string in an upper portion thereof (a list area Z) as a list, and displays a portion of an explanatory sentence corresponding to a word being selected in a lower portion thereof (a preview area Y). When the user decides a word by depressing a decision key, clicking a mouse, or touching with a pen, display 107 displays an explanatory sentence corresponding to the selected word on the entire surface thereof (a detailed area X) as shown in FIGS. 3(B) and 4(B).

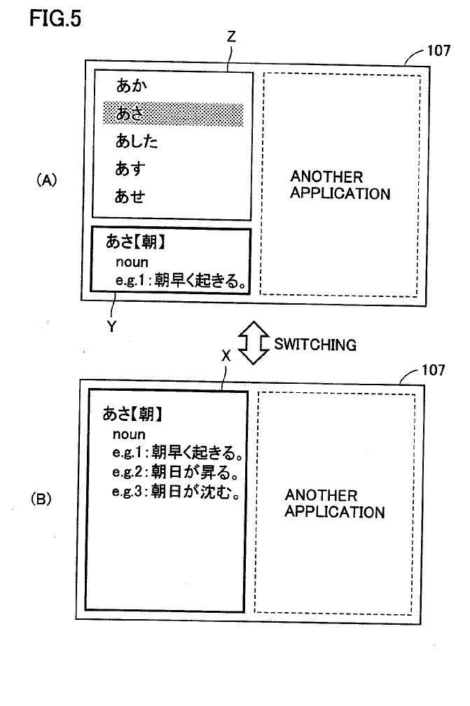

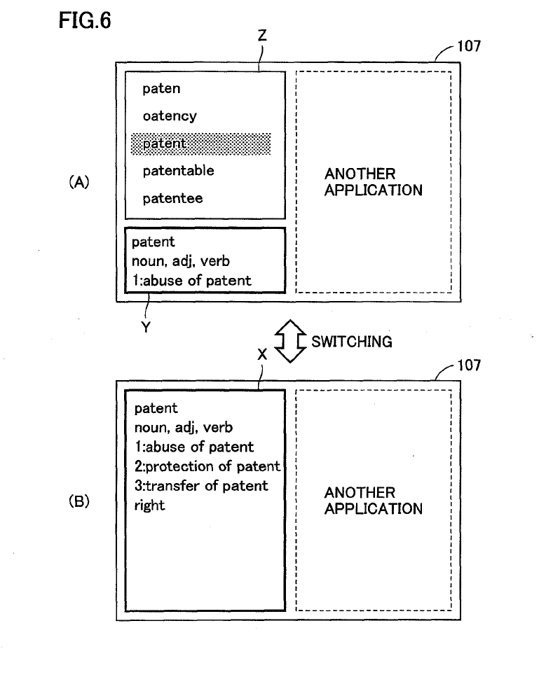

FIG. 5(A) is a second schematic diagram showing display 107 of electronic dictionary 100 for the first language in the second mode. FIG. 5(B) is a second schematic diagram showing display 107 of electronic dictionary 100 for the first language in the first mode. FIG. 6(A) is a second schematic diagram showing display 107 of electronic dictionary 100 for the second language in the second mode. FIG. 6(B) is a second schematic diagram showing display 107 of electronic dictionary 100 for the second language in the first mode. FIGS. 5 and 6 are schematic diagrams showing the state where display 107 displays information about the dictionary on a left portion thereof.

In this case, display 107 displays a screen for another application such as a Web browser, a TV image, and an e-mail program on a right portion thereof. However, display 107 may be divided not only in the horizontal direction but also in the vertical direction. That is, any method of dividing display 107 can be employed. For example, windows can be displayed in an overlapped manner.

Here, the first mode refers to a state where an explanatory sentence for a word decided from among words displayed as a list is displayed in detailed area X of display 107. In the first mode, the user can scroll the screen to view the entire explanatory sentence. On the other hand, the second mode refers to a state where words are selectably displayed in list area Z of display 107, and a portion of an explanatory sentence for a word being selected in list area Z is displayed in preview area Y. Preview area Y has an area set to be smaller than the area of detailed area X by the area of list area Z.

Electronic dictionary 100 may inform the user of the range currently displayed in electronic dictionary 100 by displaying a scroll bar, a value as a percentage, and the like, in both the first mode and the second mode. Further, electronic dictionary 100 may display the range desired by the user in accordance with manipulation of the scroll bar by the user.

As shown in FIGS. 5(A) and 6(A), display 107 selectably displays a plurality of words corresponding to an input character string in an upper left portion thereof (list area Z) as a list, and displays a portion of an explanatory sentence corresponding to a word being selected in a lower left portion thereof (preview area Y). When the user decides a word, display 107 displays an explanatory sentence corresponding to the selected word on the left portion thereof (detailed area X) as shown in FIGS. 5(B) and 6(B).

Although the description has been given of the case where the state of selection is indicated by changing a background color of a selected line, the state of selection may be indicated by inverting a background color and a character color of a selected line, underlining characters in a selected line, changing a character color of a selected line, or changing a font size of characters in a selected line.

Further, if the user changes a word being selected using for example an up/down key, electronic dictionary 100 switches display in preview area Y in accordance with the operation. That is, electronic dictionary 100 previews a newly selected word.

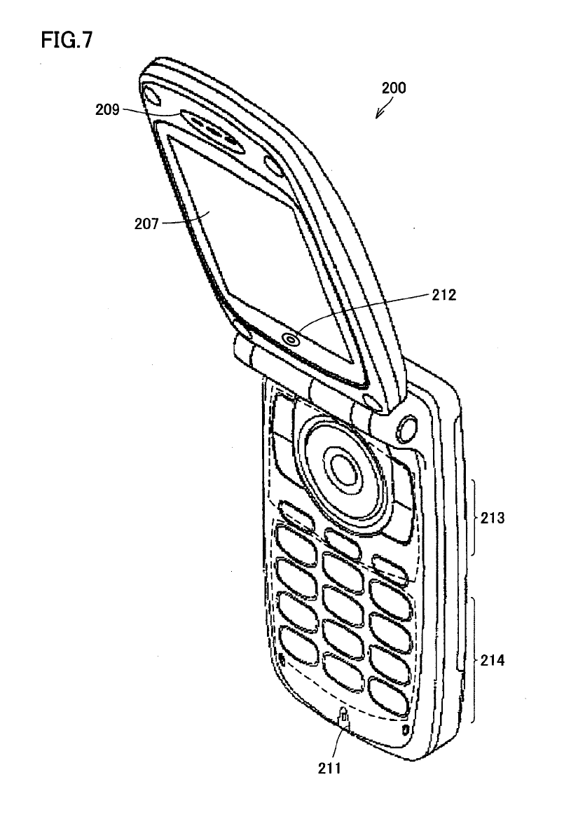

FIG. 7 is a schematic perspective view showing a mobile phone 200 having a vertically long display 207 as an example of the information processing device. As shown in FIG. 7, mobile phone 200 causes vertically long display 207 to display text based on text data. Mobile phone 200 receives input of a character string from a user via buttons 213 and a numerical keypad 214. Electronic dictionary 100 may receive manipulation from the user not only through buttons 213 and numerical keypad 214 but also through, for example, a touch panel sensor, a magnetic field sensor, and an acceleration sensor.

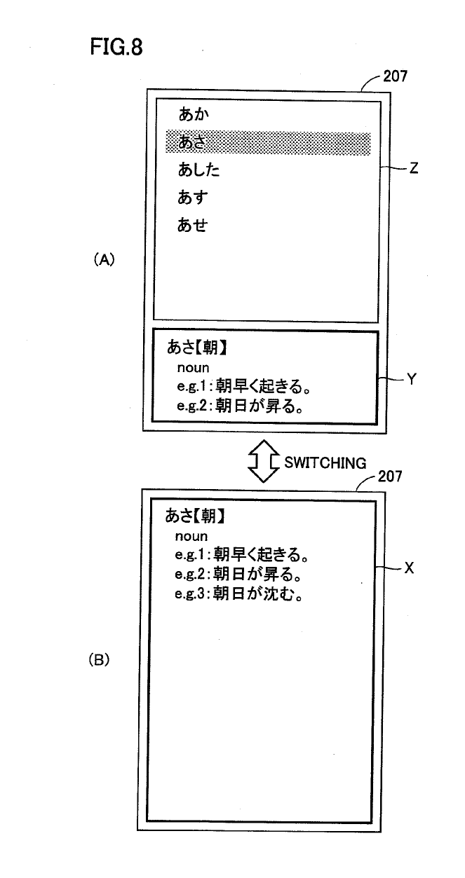

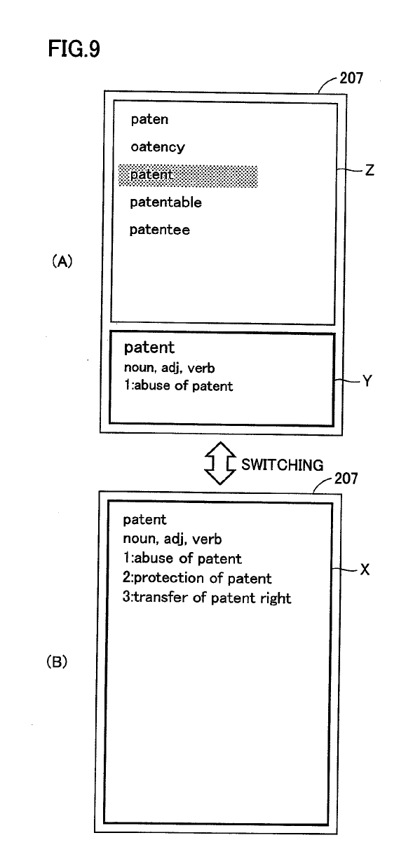

FIG. 8(A) is a first schematic diagram showing display 207 of mobile phone 200 for the first language in a second mode. FIG. 8(B) is a second schematic diagram showing display 207 of mobile phone 200 for the first language in a first mode. FIG. 9(A) is a first schematic diagram showing display 207 of mobile phone 200 for the second language in a second mode. FIG. 9(B) is a second schematic diagram showing display 207 of mobile phone 200 for the second language in a first mode. FIGS. 8 and 9 are schematic diagrams showing the state where display 207 displays information about the dictionary on an entire surface thereof. In the second mode, it is also possible to apply various variations described in the first mode.

As shown in FIGS. 8(A) and 9(A), display 207 selectably displays a plurality of words corresponding to an input character string in an upper portion thereof (list area Z) as a list, and displays a portion of an explanatory sentence corresponding to a word being selected in a lower portion thereof (preview area Y). When the user decides a word, display 207 displays an explanatory sentence corresponding to the selected word on the entire surface thereof (detailed area X) as shown in FIGS. 8(B) and 9(B).

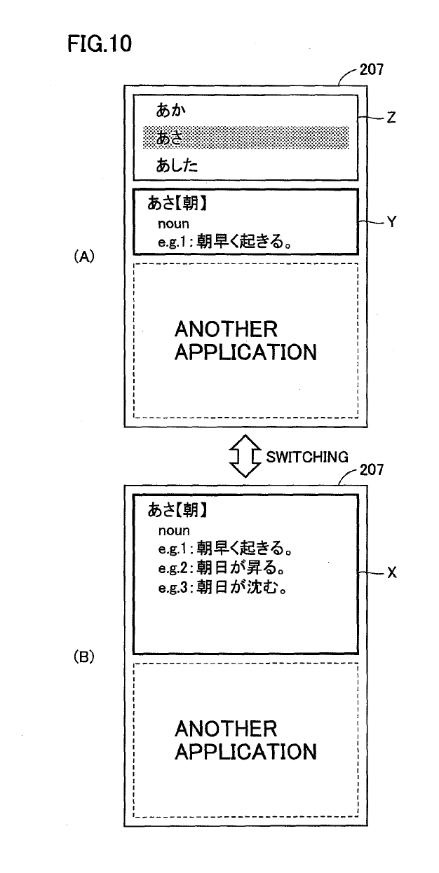

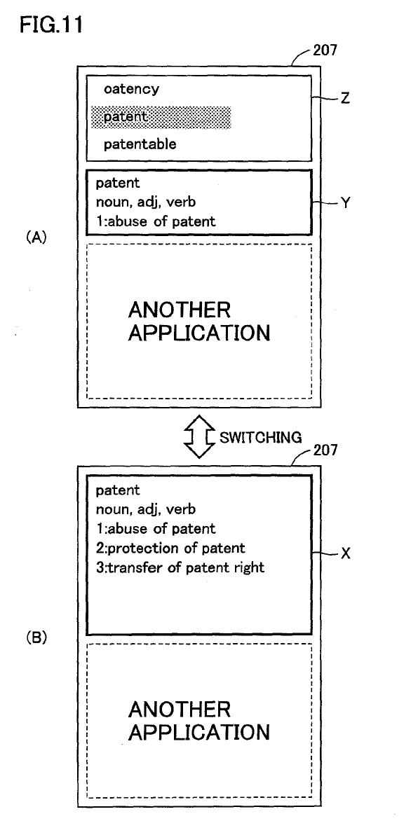

FIG. 10(A) is a second schematic diagram showing display 207 of mobile phone 200 for the first language in the second mode. FIG. 10(B) is a second schematic diagram showing display 207 of mobile phone 200 for the first language in the first mode. FIG. 11(A) is a second schematic diagram showing display 207 of mobile phone 200 for the second language in the second mode. FIG. 11(B) is a second schematic diagram showing display 207 of mobile phone 200 for the second language in the first mode. FIGS. 10 and 11 are schematic diagrams showing the state where display 207 displays information about the dictionary on an upper portion thereof. Display 207 displays a screen for another application such as a Web browser, a TV image, and an e-mail program on a lower portion thereof.

As shown in FIGS. 10(A) and 11(A), display 207 selectably displays a plurality of words corresponding to an input character string in an upper area (list area Z) of the upper portion thereof as a list, and displays a portion of an explanatory sentence corresponding to a word being selected in a lower area (preview area Y) of the upper portion thereof. When the user decides a word, display 207 displays an explanatory sentence corresponding to the selected word on the upper portion thereof (detailed area X) as shown in FIGS. 10(B) and 11(B).

Electronic dictionary 100 and mobile phone 200 in accordance with the present embodiment display text in detailed area X and display text in preview area Y based on the same text data stored in the storage medium. That is, electronic dictionary 100 and mobile phone 200 display text of the same content in detailed area X and preview area Y.

However, in electronic dictionary 100 and mobile phone 200 in accordance with the present embodiment, the number of characters of text that can be displayed in detailed area X is different from the number of characters of text that can be displayed in preview area Y. Therefore, in electronic dictionary 100 and mobile phone 200 in accordance with the present embodiment, text of the same content is displayed in different display manners when it is displayed in detailed area X and when it is displayed in preview area Y.

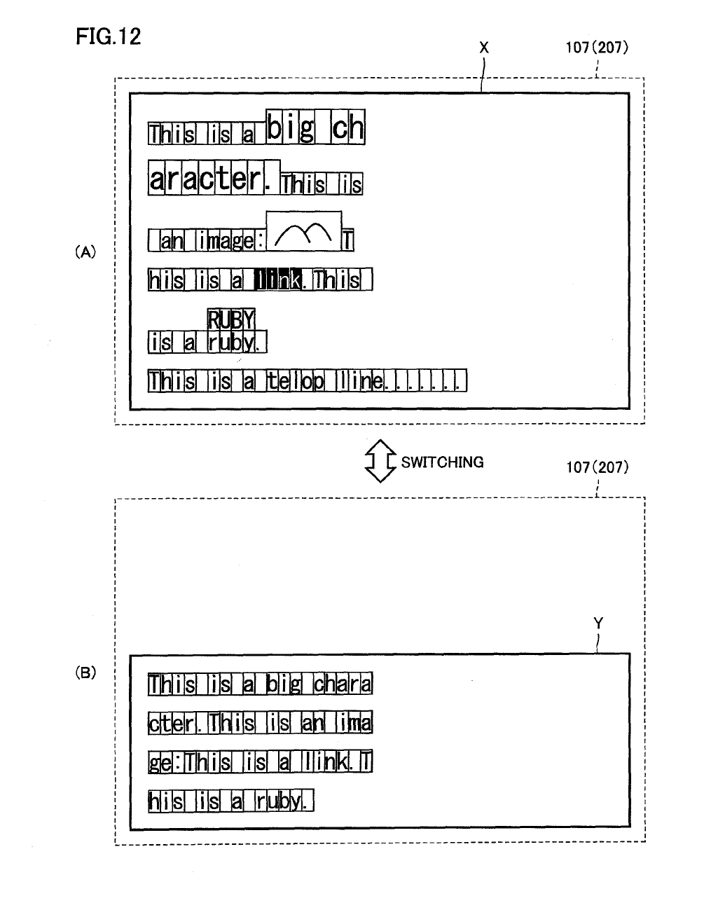

FIG. 12(A) is a schematic diagram showing a screen displayed in detailed area X of display 107 (207). FIG. 12(B) is a schematic diagram showing a screen displayed in preview area Y of display 107 (207).

As shown in FIG. 12(A), in the first mode, display 107 displays, for example, a sentence explaining a word in detailed area X larger than preview area Y. On this occasion, display 107 displays text in a large font size, image data, underlined or colored text (presence or absence of a link), text with ruby (hiragana indicated beside each kanji), a dynamically displayed telop, and the like in accordance with text data corresponding to a word decided by the user and a display attribute corresponding to the text data.

Then, as shown in FIG. 12(B), in the second mode, display 107 displays, for example, a sentence explaining a word in preview area Y smaller than detailed area X. On this occasion, display 107 displays text in a small font size, a stopped telop, a link not underlined or colored, text with no ruby, and the like in accordance with text data corresponding to a word being selected and a predetermined display attribute. In this case, display 107 does not display an image.

In FIGS. 12(A) and 12(B), since the sentence explaining a word is short, the entire sentence explaining a word is displayed in preview area Y. However, if the sentence explaining a word is longer, the entire sentence is displayed in detailed area X whereas only a portion of the sentence may be displayed in preview area Y. In addition, if the sentence explaining a word is further longer, only a portion of the sentence may be displayed even in detailed area X.

As described above, the information processing device in accordance with the present embodiment displays text of the same content in preview area Y and detailed area X based on the same text data. However, the information processing device in accordance with the present embodiment displays text in detailed area X based on a first display attribute, and displays text in preview area Y based on a second display attribute. That is, the information processing device in accordance with the present embodiment can display text of the same content in a more appropriate display manner for the area of each display area and for each display mode.

Hereinafter, a configuration of the information processing device for implementing such an operation (text display processing) will be described in detail.

<Hardware Configuration of Electronic Dictionary 100>

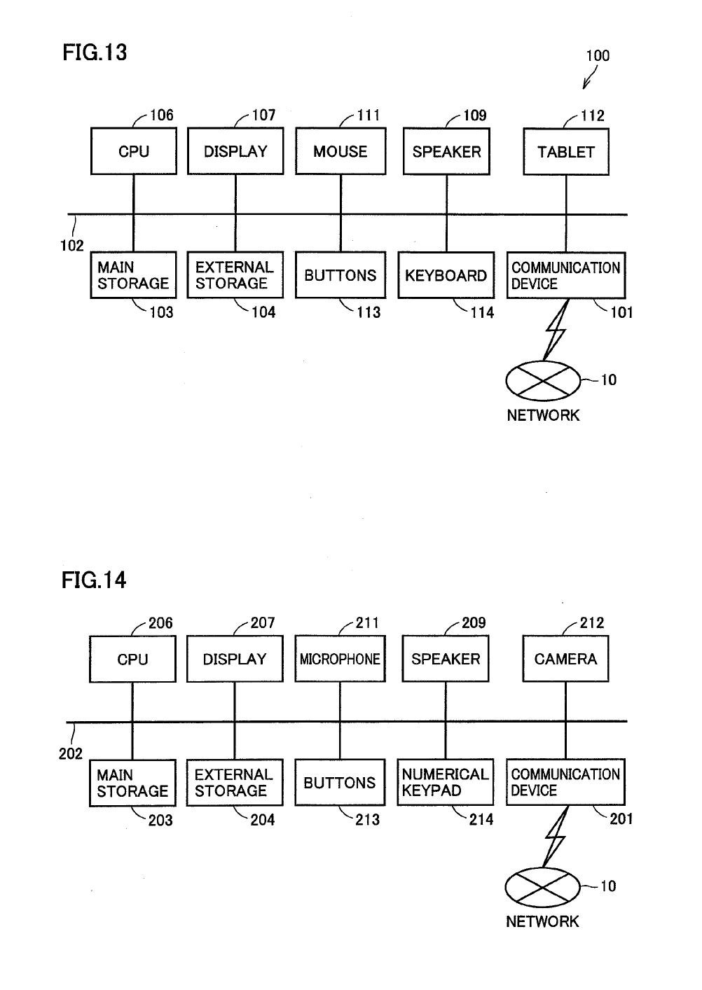

Firstly, electronic dictionary 100 as an example of the information processing device will be described. FIG. 13 is a control block diagram showing a hardware configuration of electronic dictionary 100 as an example of the information processing device in accordance with the present embodiment.

As shown in FIGS. 1 and 13, electronic dictionary 100 in accordance with the present embodiment includes a communication device 101 transmitting and receiving a communication signal, a CPU (Central Processing Unit) 106, a main storage medium 103 such as a RAM (Random Access Memory), an external storage medium 104 such as an SD card, display 107 displaying text, a speaker 109 outputting audio based on audio data from CPU 106, a mouse 111 receiving an instruction to move a pointer and the like by being clicked or slid, a tablet 112 receiving an instruction to move a pointer and the like via a stylus pen or a finger, buttons 113 receiving a selection instruction and a decision instruction, and keyboard 114 receiving input of a character string, that are mutually connected by an internal bus 102.

Communication device 101 converts communication data from CPU 106 into a communication signal, and sends the communication signal to a network 10 via an antenna. Communication device 101 converts a communication signal received from network 10 via the antenna into communication data, and inputs the communication data to CPU 106.

Display 107 includes a liquid crystal panel or a CRT, and displays text and image based on data output by CPU 106.

Mouse 111 receives information from the user by being clicked or slid. Buttons 113 receive from the user an instruction to select a word, and an instruction to decide a word for which an explanatory sentence should be displayed in detailed area X. Keyboard 114 receives input of a character string from the user.

Information to be input is not limited to alphanumeric characters, and hiragana, katakana, and kanji can also be input. That is, the user can input hiragana and katakana to electronic dictionary 100 or perform kana kanji conversion using an FEP (front-end processor) by switching between input modes.

Main storage medium 103 stores various information, and includes, for example, a RAM temporarily storing data necessary for CPU 106 to execute a program, a non-volatile ROM (Read Only Memory) storing a control program, and the like. Main storage medium 103 may be a hard disk.

External storage medium 104 is removably mounted to electronic dictionary 100, and stores, for example, dictionary data and the like. CPU 106 reads data from external storage medium 104 via an input interface. External storage medium 104 is implemented by a SD card, a USB memory, and the like. It is to be noted that main storage medium 103 may store dictionary data, and main storage medium 103 and external storage medium 104 may store different types of dictionary data.

Data stored in main storage medium 103 and external storage medium 104 are read by the information processing device (computer) such as electronic dictionary 100. Electronic dictionary 100 implements, for example, a dictionary function, by executing a variety of application programs based on the read data. More specifically, CPU 106 searches for a word, causes an explanatory sentence corresponding to the word to be displayed, and causes the explanatory sentence to be displayed in various display manners, based on the data read from main storage medium 103 or external storage medium 104.

CPU 106 is a device that controls each component of electronic dictionary 100 and performs various computations. In addition, as described later, CPU 106 performs the text display processing by executing the text display program, and stores a result of the processing in a predetermined region in main storage medium 103, outputs the result of the processing to display 107 via internal bus 102, and transmits the result of the processing to an external device via communication device 101.

<Hardware Configuration of Mobile Phone 200>

Next, mobile phone 200 as an example of the information processing device will be described. FIG. 14 is a control block diagram showing a hardware configuration of mobile phone 200 as an example of the information processing device in accordance with the present embodiment.

As shown in FIGS. 7 and 14, mobile phone 200 in accordance with the present embodiment includes a communication device 201, a CPU 206, a main storage medium 203, an external storage medium 204, display 207 displaying text and an image, a speaker 209 outputting audio based on audio data from CPU 206, a microphone 211 receiving audio from the user and inputting audio data to CPU 206, a camera 212, buttons 213 receiving a selection instruction and a decision instruction, and numerical keypad 214 receiving input of a character string, that are mutually connected by an internal bus 202.

Since the configuration of each component of mobile phone 200 is identical to that of electronic dictionary 100, the description thereof will not be repeated here.

The information processing device and the text display processing in accordance with the present embodiment are implemented by hardware such as electronic dictionary 100 and mobile phone 200 and software such as a control program. Generally, such software is distributed in the state stored in external storage medium 104 (204) such as an SD card and a USB memory, or through the network and the like. Then, the software is read from the external storage medium 104 (204) or received by communication device 101 (201), and stored in main storage medium 103 (203). Subsequently, the software is read from main storage medium 103 (203) and executed by CPU 106 (206).

<Functional Configuration>

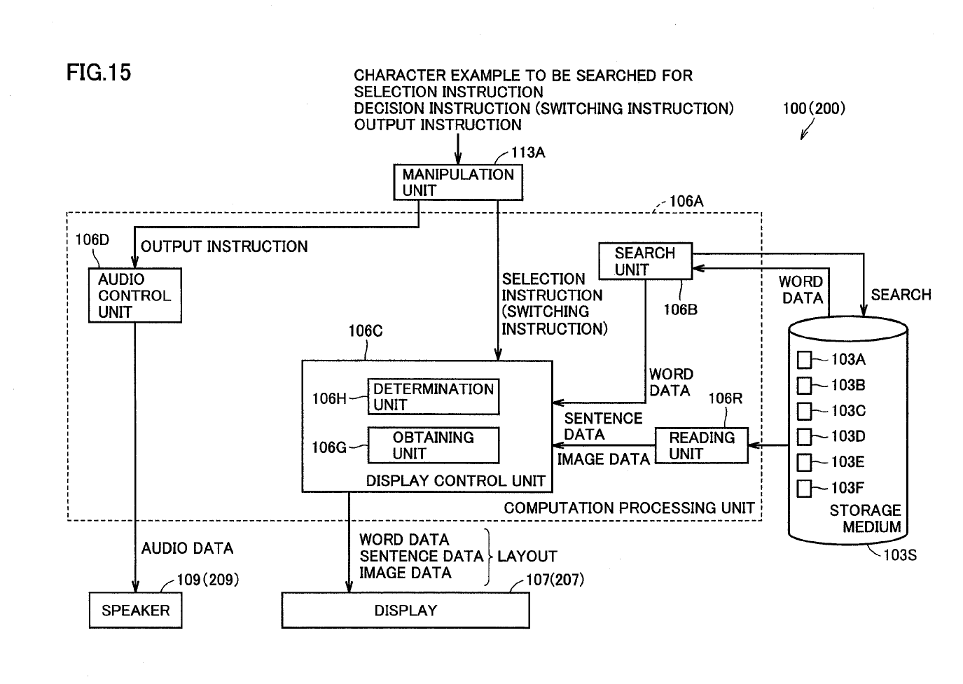

Next, functions of the information processing device in accordance with the present embodiment will be described. FIG. 15 is a block diagram showing a functional configuration of the information processing device in accordance with the present embodiment. As shown in FIG. 15, the information processing device in accordance with the present embodiment includes a manipulation unit 113A, a computation processing unit 106A, display 107, and speaker 109.

Manipulation unit 113A is implemented, for example, by mouse 111, buttons 113 (213), keyboard 114, and numerical keypad 214. Manipulation unit 113A receives a character string to be searched for from the user. Manipulation unit 113A receives a switching instruction to switch between display states by display 107. Manipulation unit 113A receives an instruction to output audio. Manipulation unit 113A inputs these instructions to a display control unit 106C and the like.

More specifically, manipulation unit 113A receives an instruction to select a word. Manipulation unit 113A receives an instruction to decide a word (a first instruction). Manipulation unit 113A receives an instruction to return from a screen displaying a detailed explanatory sentence for a word to a screen for selecting a word (a screen for inputting a character string) (a second instruction).

Display 107 (207) displays an image, text, and the like based on data from display control unit 106C.

(Functional Configuration of Storage Medium 103S)

A storage medium 103S is implemented by main storage medium 103 (203) and external storage medium 104 (204). Storage medium 103S stores a dictionary database 103A, an element database 103B, a line database 103C, an image data 103E, an audio data 103F, and the like.

More specifically, for example, CPU 106 generates element database 103B and line database 103C based on dictionary database 103A and image data 103E stored in external storage medium 104 (layout processing), and stores them in main storage medium 103, in accordance with an instruction from manipulation unit 113A. Further, for example, CPU 106 outputs audio via speaker 109 based on audio data 103F stored in external storage medium 104.

Here, a non-volatile internal memory of the information processing device may have a function as external storage medium 104, and a volatile internal memory of the information processing device may have a function as main storage medium 103.

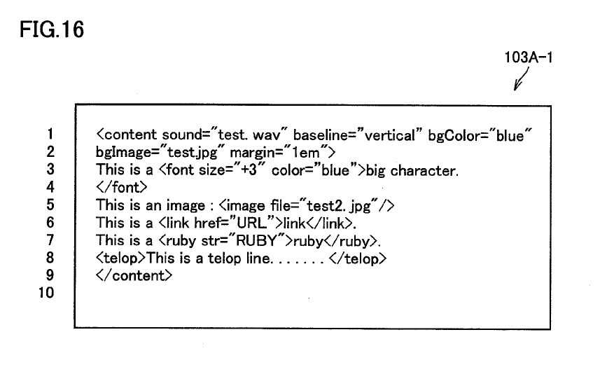

Dictionary database 103A stores text data 103A-1 indicating a sentence for explaining a word to associate it with each word data. FIG. 16 is a schematic diagram showing text data 103A-1 for displaying a sentence for explaining one word (see FIG. 12).

As shown in FIG. 16, each text data 103A-1 is configured by, for example, HTML data, XML data, and the like. Each text data 103A-1 stores a plurality of text to associate them with display attributes thereof. A display attribute indicates a display manner of associated text when the text is displayed on display 107.

More specifically, if text data 103A-1 is HTML data, text sandwiched between a start tag and an end tag is stored in text data 103A-1. The start tag includes a display attribute of the associated text.

The display attribute associated with the text includes a first display attribute value included in a first display attribute value group. For example, the first display attribute group is a font size group. The first display attribute value is a font size. Specifically, text data 103A-1 includes a code <font size=“+3”> as a start tag. Then, in this case, text data 103A-1 includes a code </font> as an end tag after text “big character”.

On the other hand, storage medium 103S stores a predetermined display attribute, aside from text data 103A-1. The predetermined display attribute includes a second display attribute value included in the first display attribute value group. The second display attribute value is a predetermined font size. That is, storage medium 103S stores, for example, a font size set for preview area Y.

Further, in text data 103A-1, the display attribute associated with the text includes a third display attribute value included in a second display attribute value group. For example, the third display attribute group is a background color group. The third display attribute value is a background color. Specifically, text data 103A-1 includes a code <bgColor=“blue”> as a start tag.

On the other hand, storage medium 103S stores a fourth display attribute value included in the second display attribute value group, aside from text data 103A-1. The fourth display attribute value is a predetermined background color. That is, storage medium 103S stores, for example, a background color set for preview area Y.

Further, text data 103A-1 includes a code <bgImage=“test.jpg”> as a start tag designating a background image. Furthermore, text data 103A-1 includes a code <margin=“lem”> as a start tag designating a margin amount. In addition, text data 103A-1 may include a start tag designating a character space amount or a line space amount.

Further, in text data 103A-1, the display attribute value associated with the text may be a character color included in a character color group. Specifically, text data 103A-1 includes a code <font Color=“blue”> as a start tag. In this case, text data 103A-1 includes a code </font> as an end tag after target text (a character string immediately after the start tag for which a character color should be designated).

On the other hand, storage medium 103S stores a predetermined character color included in the character color group, aside from text data 103A-1. That is, storage medium 103S stores, for example, a character color set for preview area Y.

Further, text data 103A-1 includes line break designation to display text with a line break. Specifically, text data 103A-1 may include a code <br/> as a line break tag, a code <p> as a paragraph tag, and the like not shown.

Further, text data 103A-1 includes text with which a ruby attribute value indicating ruby is associated. Specifically, text data 103A-1 includes a code <ruby str=“RUBY”> as a start tag. In this case, text data 103A-1 includes a code </ruby> as an end tag after text “ruby”.

Further, text data 103A-1 includes designation to paste an image (a so-called in-line image), that is, designation of image data. Specifically, text data 103A-1 includes a code <image file=test2.jpg”/> at a position where an image is to be inserted. However, a wrapped-around image may be pasted by wraparound designation, for example, by a code <image file=“test2.jpg” align=“left”>.

Further, text data 103A-1 includes designation to output (automatically reproduce) audio, that is, designation of audio data. Specifically, text data 103A-1 includes a code <sound=test.wav“/>. In this case, storage medium 103S stores audio data to associate it with a word and text.

Further, text data 103A-1 includes text with which a change attribute value to temporally change the display manner is associated. That is, text data 103A-1 stores designation to flow (shift) display of text to associate it with the text. Specifically, text data 103A-1 includes a code <telop> or a code <marquee> not shown as a start tag. In this case, text data 103A-1 includes a code </telop> or a code </marquee> not shown as an end tag after text “This is a telop line”.

Further, text data 103A-1 includes text with which a link attribute indicating that a link is provided to the text is associated. Specifically, text data 103A-1 includes a code <link href=“URL”> as a start tag. In this case, text data 103A-1 includes a code a code </link> as an end tag after text “link”.

Further, each text data 103A-1 includes one of designation to display text included in text data 103A-1 in vertical writing and designation to display the text in horizontal writing (designation of a character string direction). Display control unit 106C causes display 107 to display the text based on the designation of a character string direction. Specifically, text data 103A-1 includes a code <content baseline=“vertical”> as a start tag.

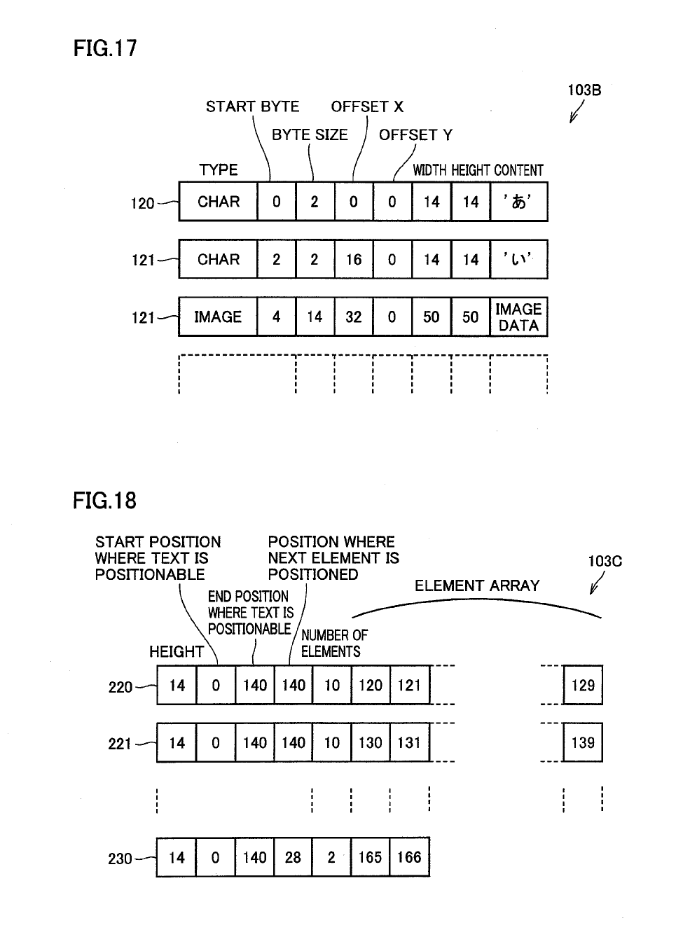

FIG. 17 is a schematic diagram showing an exemplary data structure of element data 120, 121, 122 serving as a basic unit of display layout. Hereinafter, the element of the display layout will be simply referred to as an “element”. The element corresponds to each character, each image, and the like in the display on display 107 shown in FIG. 12(A).

As shown in FIG. 17, element database 103B includes a plurality of element data 120, 121, 122. Each element has information “type”, “start byte”, “byte size”, “offset X”, “offset Y”, “width”, “height”, and “content”.

The “type” indicates a type of an element. Although only “CHAR” indicating a “character” and an “IMAGE” indicating an “image” are shown here as examples, other various types of elements, for example, a moving image element, can be included.

The “start byte” indicates where in electronic data the element is described. Here, the “start byte” indicates at how manieth byte from the beginning a leading portion of a TEXT portion or a tag indicating the element is located in HTML data.

The “byte size” indicates a data amount required for the element to be described in the electronic data. Here, it is assumed that the element is indicated with the number of bytes of a character indicating the element, or in some cases, the number of bytes including a tag, in HTML data. For example, if one character in HTML data directly serves as an element, and the character is represented for example in Shift-JIS, the byte size is “2”.

The “width” and the “height” indicate a size of an element when it is displayed. A unit thereof may be pixels (dots) or the like.

The “content” is data indicating a content for displaying each element. It is a character code in the case of a character element, image data in the case of an image element, and the like.

FIG. 18 is a schematic diagram showing an exemplary data structure of line data 220 to 230 for managing a collection of elements. Each line data corresponds to each line in the display on display 107 shown in FIG. 12(A). Since “a line in the display” corresponds to “line data” on a one-to-one basis, both cases may be simply represented as a “line” hereinafter.

As shown in FIG. 18, line database 103C includes a plurality of line data 220 to 230. Each line data 220 can have not less than 0 elements. An element owned (managed) by each line data 220 corresponds to an element such as a character belonging to a range of each line in the display. A line having 0 elements is an empty line.

Each line data 220 has information “height”, “start position where text is positionable”, “end position where text is positionable”, “position where next element is positioned”, “number of elements”, and “element array”.

The “element array” is an array of elements managed by line data within one line, and the “number of elements” is the number of elements managed within one line. The “element array” includes information identifying each element included within one line. Here, for simplicity's sake, the information is represented as the number allocated to each element in FIG. 17. Actually, in many cases, data constituting the “element array” is an array index, a memory address, or the like for each element.

The “height” is a height of a circumscribed rectangle including an entire managed element.

Turning back to FIG. 15, storage medium 103S stores image data 103E to associate it with text data 103A-1. Alternatively, storage medium 103S stores image data 103E to associate it with text included in text data 103A-1. Storage medium 103S stores audio data 103F to associate it with text data 103A-1.

(Functional Configuration of Computation Processing Unit 106A)

Computation processing unit 106A is implemented by CPU 106 (206) and the like. Computation processing unit 106A has functions of a search unit 106B, display control unit 106C, an audio control unit 106D, a reading unit (an access unit) 106R, and the like.

More specifically, the functions of computation processing unit 106A are functions implemented by CPU 106 (206) executing a control program stored in main storage medium 103 (203), external storage medium 104 (204), and the like to control each hardware shown in FIG. 13 or 14. In the present embodiment, a function for performing the text display processing is configured to be implemented by software executed on CPU 106 (206). However, a function of each block and processing in each step may be implemented by an exclusive hardware circuit and the like, instead of being implemented by software.

Hereinafter, the functions of computation processing unit 106A will be described. Search unit 106E refers to storage medium 103S, and searches for words including a character string input via manipulation unit 113A.

Reading unit 106R reads text data including at least one text with which any display attribute value is associated, from storage medium 103S. That is, reading unit 106R reads designated text data from storage medium 103S based on a command from display control unit 106C.

Further, reading unit 106R reads image data 103E corresponding to text from storage medium 103S in accordance with an output instruction from manipulation unit 113A or in accordance with a command from display control unit 106C.

Further, reading unit 106R reads audio data 103F corresponding to a word in accordance with an output instruction from manipulation unit 113A or in accordance with a command from audio control unit 106D.

More specifically, if the dictionary data is stored in main storage medium 103 (203), reading unit 106R reads text data 103A-1 from main storage medium 103 (203). On the other hand, if the dictionary data is stored in external storage medium 104 (204), reading unit 106R reads text data 103A-1 from external storage medium 104 (204).

Audio control unit 106D reads audio data 103F from storage medium 103S, and outputs audio via speaker 109 (209). More specifically, in the first mode, audio control unit 106D refers to text data 103A-1 and reads audio data 103F corresponding to text data 103A-1, as with display control unit 106C described later. Then, audio control unit 106D causes speaker 109 (209) to output audio based on audio data 103F. However, in the second mode, audio control unit 106D neglects a link to audio data 103F (an address of audio data 103F) included in text data 103A-1. That is, in the second mode, audio control unit 106D does not function.

Display control unit 106C causes display 107 to display text based on text data 103A-1. In the first mode, display control unit 106C causes display 107 to display the text within a first display area based on a display attribute value included in text data 103A-1. On the other hand, in the second mode, display control unit 106C refers to the text data and causes display 107 to display the text within a second display area based on a predetermined display attribute value or neglecting the display attribute value in text data 103A-1.

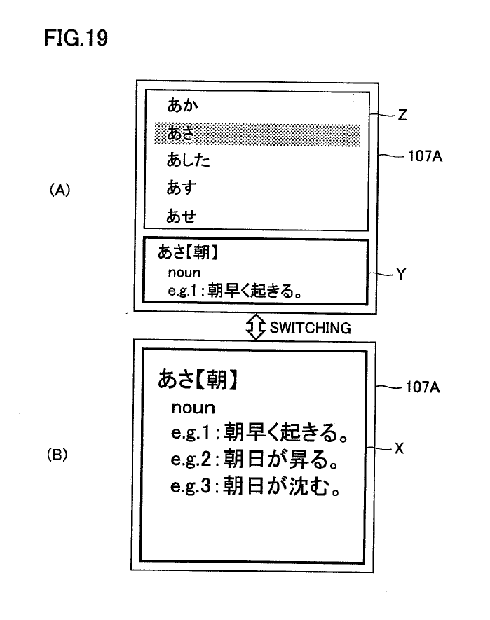

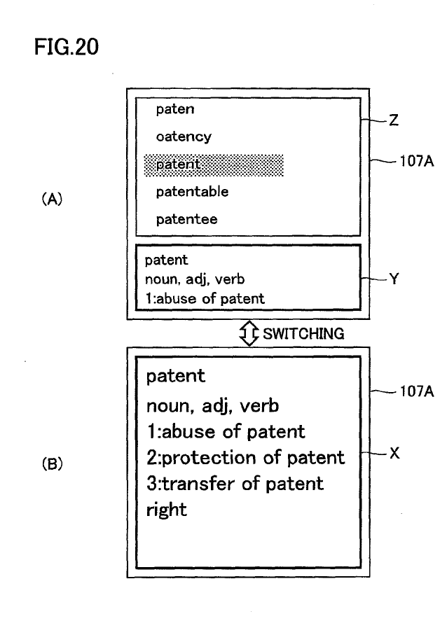

FIG. 19(A) is a first schematic diagram showing display 107 for the first language in the second mode in accordance with the present embodiment. FIG. 19(B) is a first schematic diagram showing display 107 for the first language in the first mode in accordance with the present embodiment. FIG. 20(A) is a first schematic diagram showing display 107 for the second language in the second mode in accordance with the present embodiment. FIG. 20(B) is a first schematic diagram showing display 107 for the second language in the first mode in accordance with the present embodiment.

As shown in FIGS. 19(A) and 20(A), in the second mode in accordance with the present embodiment, display control unit 106C causes display 107 to display list area Z and preview area Y. As shown in FIGS. 19(b) and 20(B), in the first mode in accordance with the present embodiment, display control unit 106C causes display 107 to display detailed area X. As shown in FIGS. 19 and 20, preview area Y has an area smaller than that of detailed area X.

More specifically, in the second mode, display control unit 106C causes display 107 to selectably display a plurality of words searched by search unit 106B as a list within list area Z, and to display a portion of a sentence explaining a word being selected in preview area Y based on text data 103A-1 corresponding to the word being selected.

Display control unit 106C shifts from the second mode to the first mode in accordance with an instruction to decide a word (the first instruction) input via manipulation unit 113A. Further, display control unit 106C shifts from the first mode to the second mode in accordance with an instruction to return to a previous screen, that is, an instruction to cancel detailed display of an explanatory sentence (the second instruction) input via manipulation unit 113A.

(Specific Functional Configuration of Display Control Unit 106C)

Hereinafter, the function of display control unit 106C will be described in further detail. Display control unit 106C includes functions of an obtaining unit 106G and a determination unit 106H. Determination unit 106H determines whether or not the first display attribute value is not less than the second display attribute value. For example, determination unit 106H determines whether or not a font size of text designated in text data 103A-1 is not less than a predetermined font size (threshold value). However, if the font size of the text is not particularly designated, a standard font size maintained beforehand in an application can also be used.

Obtaining unit 106G obtains the positions, the sizes, and the shapes of the display areas (detailed area X, preview area Y, list area Z) in which text should be displayed.

If the first display attribute value is not less than the second display attribute value in the second mode, display control unit 106C causes display 107 to display text based on the second display attribute value or by neglecting the first display attribute value in text data 103A-1. If the first display attribute value is less than the second display attribute value in the second mode, display control unit 106C causes display 107 to display text based on the first display attribute value.

As shown in FIGS. 19(B) and 20(B), when display control unit 106C causes text to be displayed in detailed area X, display control unit 106C causes the text to be displayed based on the first display attribute value (a large font size) included in text data 103A-1. On the other hand, as shown in FIGS. 19(A) and 20(A), when display control unit 106C causes text to be displayed in preview area Y, display control unit 106C causes the text to be displayed based on the predetermined second display attribute value (a small font size).

Here, the text shown in FIG. 19 is displayed based on text data 103A-1 as described below. It is to be noted that, in examples of text data 103A-1 hereinafter, <br/> indicates a line break tag, <font>, </font> indicate font tags, “size” indicates a font size attribute, “color” indicates a font color attribute, <content> indicates a content tag, “baseline=“vertical”” indicates designation of a vertical writing attribute, <ruby>, </ruby> indicate ruby tags, “str” indicates a ruby character attribute, and <telop>, </telop> indicate telop tags.

In addition, in the description below, bold parentheses in the drawings are indicated by brackets [ ].

<content margin=“1em”>
<font size=“+2”> [symbol] [ [symbol] ]<br/>
noun<br/>
e.g.1: [symbol] <br/>
e.g.2: [symbol] <br/>
e.g.3: [symbol] </font><br/>
</content>

As shown in FIG. 19(B), display control unit 106C causes the text to be displayed in detailed area X based on text data 103A-1 as described above. As shown in FIG. 19(A), display control unit 106C causes the text included in text data 103A-1 as described above to be displayed in preview area Y, all with the second display attribute value (small font size).

For reference, the text shown in FIG. 20 is displayed based on text data 103A-1 as described below.

<content margin=“1em”>
<font size=“+2”>patent<br/>
noun, adj, verb<br/>
1:abuse of patent<br/>
2:protection of patent<br/>
3:transfer of patent right</font><br/>
</content>

As shown in FIG. 20(B), display control unit 106C causes the text to be displayed in detailed area X based on text data 103A-1 as described above. As shown in FIG. 20(A), display control unit 106C causes the text included in text data 103A-1 as described above to be displayed in preview area Y, all with the second display attribute value (small font size).

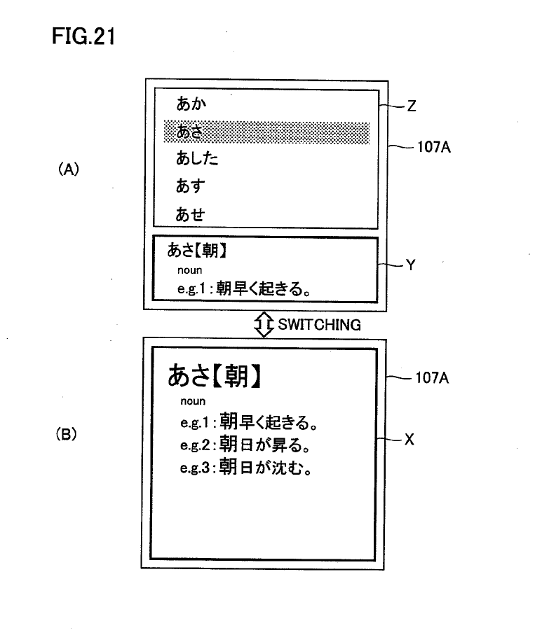

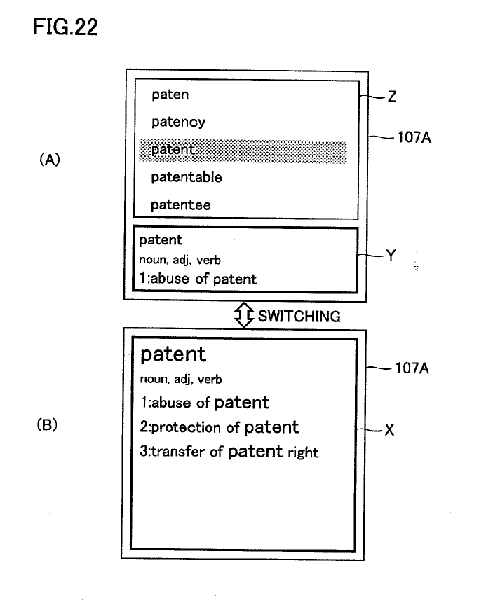

FIG. 21(A) is a second schematic diagram showing display 107 for the first language in the second mode in accordance with the present embodiment. FIG. 21(B) is a second schematic diagram showing display 107 for the first language in the first mode in accordance with the present embodiment. FIG. 22(A) is a second schematic diagram showing display 107 for the second language in the second mode in accordance with the present embodiment. FIG. 22(B) is a second schematic diagram showing display 107 for the second language in the first mode in accordance with the present embodiment.

As shown in FIGS. 21(B) and 22(B), when display control unit 106C causes text to be displayed in detailed area X, display control unit 106C causes the text to be displayed based on the first display attribute value included in text data 103A-1. On the other hand, as shown in FIGS. 21(A) and 22(A), when display control unit 106C causes text to be displayed in preview area Y, display control unit 106C causes display 107 to display each text based on the second display attribute value if the first display attribute value of each text is not less than the second display attribute value.

Here, the text shown in FIG. 21 is displayed based on text data 103A-1 as described below.

<content margin=“1em”>
<font size=“+3” color=“red”> [symbol] </font><br/>
<font size=“−1” color=“green”>noun</font><br/>
e.g.1:<font size=“+1”> [symbol] </font> [symbol] <br/>
e.g.2:<font size=“+1”> [symbol] </font> [symbol] <br/>
e.g.3:<font size=“+1”> [symbol] </font> [symbol] <br/>
</content>

As shown in FIG. 21(B), display control unit 106C causes the text to be displayed in detailed area X based on text data 103A-1 as described above. As shown in FIG. 21(A), display control unit 106C causes text with a font size of not less than +1, for example, text for which <font size=“+1”> or <font size=“+3”> is designated, of the text included in text data 103A-1 as described above, to be displayed in preview area Y, all with the second display attribute value (<font size=“0”>).

Specifically, if determination unit 106H determines that the first display attribute value of text [symbol] is not less than the second display attribute value or determines that the first display attribute value of text of a line [symbol] is not less than the second display attribute value as shown in FIG. 21(B), display control unit 106C causes display 107 to display the text [symbol] and [symbol] based on the second display attribute value when the text is displayed in preview area Y, as shown in FIG. 21(A). If determination unit 106H determines that the first display attribute value of text other than [symbol] is less than the second display attribute value, display control unit 106C causes display 107 to display the text other than [symbol] based on the first display attribute value when the text is displayed in preview area Y, as shown in FIG. 21(A).

Here, display control unit 106C causes text for which the first display attribute value smaller than the second display attribute value is designated, for example, text “noun” immediately after a tag <font size=“−1, to be displayed based on the first display attribute value. However, display control unit 106C may be configured to cause text for which the first display attribute value smaller than the second display attribute value is designated to be also displayed based on the predetermined second display attribute value.

For reference, the text shown in FIG. 22 is displayed based on text data 103A-1 as described below.

<content margin=“1em”>
<font size=“+3” color=“red”>patent</font><br/>
<font size=“−1” color=“green”>noun, adj, verb</font><br/>
1:abuse of <font size=“+1”>patent</font><br/>
2:protection of <font size=“+1”>patent</font><br/>
3:taransfer of <font size=“+1”>patent</font> right<br/>
</content>

As shown in FIG. 22(B), display control unit 106C causes the text to be displayed in detailed area X based on text data 103A-1 as described above. As shown in FIG. 22(A), display control unit 106C causes text with a font size of not less than +1, for example, text for which <font size=“+1”> or <font size=“+3”> is designated, of the text included in text data 103A-1 as described above, to be displayed in preview area Y, all with the second display attribute value (<font size=“0”>).

Specifically, if determination unit 106H determines that the first display attribute value of text “patent” is not less than the second display attribute value as shown in FIG. 22(B), display control unit 106C causes display 107 to display the text “patent” based on the second display attribute value when the text is displayed in preview area Y, as shown in FIG. 22(A). If determination unit 106H determines that the first display attribute value of text other than “patent” is less than the second display attribute value, display control unit 106C causes display 107 to display the text other than “patent” based on the second display attribute value when the text is displayed in preview area Y, as shown in FIG. 22(A).

Here, display control unit 106C causes text for which the first display attribute value smaller than the second display attribute value is designated, for example, text “noun, adj, verb” immediately after a tag <font size=“−1>, to be displayed based on the first display attribute value. However, display control unit 106C may be configured to cause text for which the first display attribute value smaller than the second display attribute value is designated to be also displayed based on the predetermined second display attribute value.

Further, in the first mode, display control unit 106C in accordance with the present embodiment causes display 107 to display text based on designation of a character string direction included in text data 103A-1. In the second mode, display control unit 106C causes display 107 to display text based on preset designation of a character string direction or neglecting the designation of a character string direction in text data 103A-1.

Further, in the first mode, display control unit 106C causes display 107 to display text based on designation of a character string direction included in text data 103A-1. In the second mode, display control unit 106C causes display 107 to display text based on preset designation of a character string direction or neglecting the designation of a character string direction in text data 103A-1.

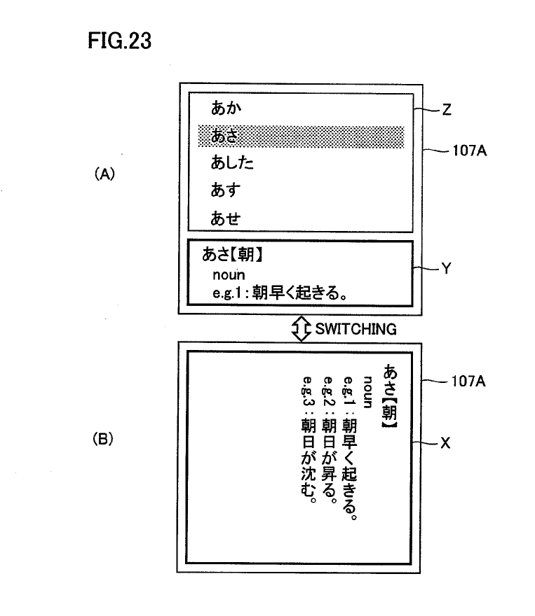

FIG. 23(A) is a third schematic diagram showing display 107 in the second mode in accordance with the present embodiment. FIG. 23(B) is a third schematic diagram showing display 107 in the first mode in accordance with the present embodiment.

As shown in FIG. 23(B), when display control unit 106C causes text to be displayed in detailed area X, display control unit 106C causes the text to be displayed based on designation of a character string direction included in text data 103A-1. Specifically, if text data 103A-1 includes vertical writing designation to display text in vertical writing, and designation to display text in horizontal writing is set beforehand in main storage medium 103, display control unit 106C causes display 107 to display the text in vertical writing based on the designation of a character string direction.

It is to be noted that, with regard to some symbols such as arrows, using the same font for vertical writing and horizontal writing may lead to difference in meaning and difficulty in understanding. In such a case, it is necessary to additionally prepare a font for vertical writing.

On the other hand, as shown in FIG. 23(A), when display control unit 106C causes text to be displayed in preview area Y, display control unit 106C causes the text to be displayed based on predetermined designation of a character string direction. For example, if text data 103A-1 includes vertical writing designation to display text in vertical writing, and designation to display text in horizontal writing is set beforehand in main storage medium 103, display control unit 106C causes display 107 to display the text in horizontal writing even though text data 103A-1 includes the vertical writing designation.

Here, the text shown in FIG. 23(A) is displayed based on text data 103A-1 as described below.

<content baseline=“vertical” margin=“1em”> [symbol]
<br/>
noun<br/>
e.g.1: [symbol] <br/>
e.g.2: [symbol] <br/>
e.g.3: [symbol] <br/>
</content>

Display control unit 106C causes the text to be displayed in detailed area X based on text data 103A-1 as described above. Then, display control unit 106C causes the text to be displayed in preview area Y based on text data 103A-1, neglecting designation of a vertical writing attribute, that is, a code <content baseline=“vertical”>.

Display control unit 106C may determine whether preview area Y is horizontally long or vertically long by obtaining the size and the shape of preview area Y via obtaining unit 106G, and then decide a character string direction. That is, if preview area Y is horizontally long, display control unit 106C may cause the text to be displayed in horizontal writing irrespective of designation of a character string direction in text data 103A-1, and if preview area Y is vertically long, display control unit 106C may cause the text to be displayed in vertical writing irrespective of designation of a character string direction in text data 103A-1.

Generally, there is a tendency that text is difficult to read if a length of one line is too short. In addition, it is easier to read text if a line direction in preview area Y matches a line direction in list area Z.

In the first mode, display control unit 106C refers to text data 103A-1, and causes display 107 to display text with a line break based on line break designation. In the second mode, display control unit 106C refers to text data 103A-1, and causes display 107 to display text with no line break by neglecting the line break designation in text data 103A-1.

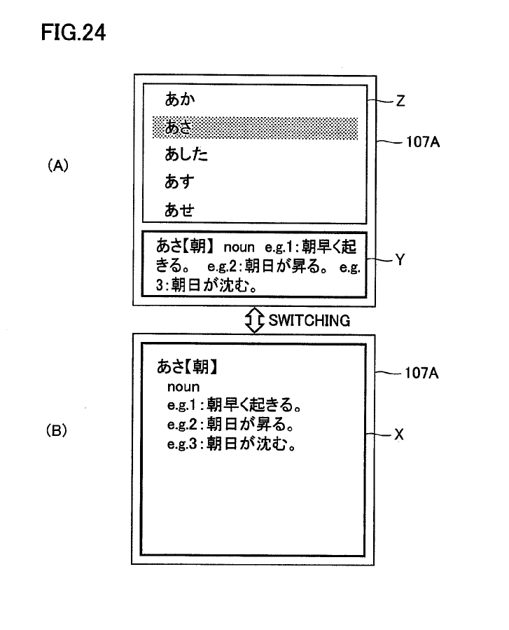

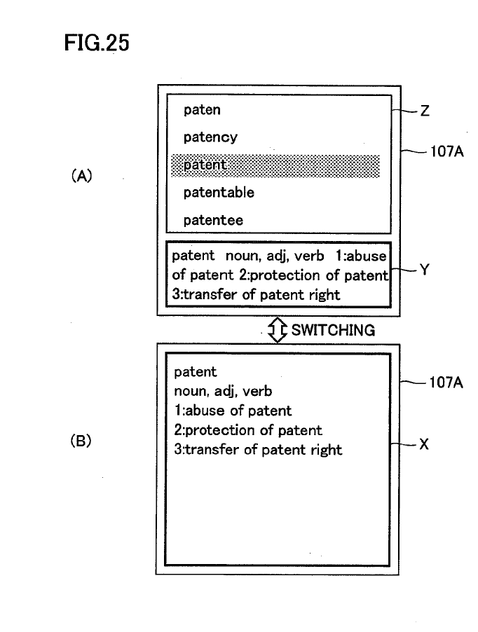

FIG. 24(A) is a fourth schematic diagram showing display 107 for the first language in the second mode in accordance with the present embodiment. FIG. 24(B) is a fourth schematic diagram showing display 107 for the first language in the first mode in accordance with the present embodiment. FIG. 25(A) is a fourth schematic diagram showing display 107 for the second language in the second mode in accordance with the present embodiment. FIG. 25(B) is a fourth schematic diagram showing display 107 for the second language in the first mode in accordance with the present embodiment.

As shown in FIGS. 24(B) and 25(B), when display control unit 106C causes text to be displayed in detailed area X, display control unit 106C causes the text to be displayed with a line break based on line break designation included in text data 103A-1. On the other hand, as shown in FIGS. 24(A) and 25(A), when display control unit 106C causes text to be displayed in preview area Y, display control unit 106C causes the text to be displayed with no line break, neglecting the line break designation.

Specifically, even if text data 103A-1 includes a line break tag <br/> after text “ [symbol] as shown in FIG. 24(B), when display control unit 106C causes the text to be displayed in preview area Y, display control unit 106C causes display 107 to display the text in a display manner [symbol] e.g. 2” by neglecting the line break tag as shown in FIG. 24(A). It is noted for reference that, even if text data 103A-1 includes a line break tag <br/> after text “1:abuse of patent” as shown in FIG. 25(B), when display control unit 106C causes the text to be displayed in preview area Y, display control unit 106C causes display 107 to display the text in a display manner “of patent 2:protection” by neglecting the line break tag as shown in FIG. 25(A).

Since the text shown in FIG. 24 is displayed based on text data identical to text data 103A-1 in accordance with FIG. 19 except for designation of a font size, the description thereof will not be repeated here. In addition, since the text shown in FIG. 25 is displayed based on text data identical to text data 103A-1 in accordance with FIG. 20 except for designation of a font size, the description thereof will not be repeated here.

In the first mode, display control unit 106C refers to text data 103A-1, and causes display 107 to display text and to display ruby on a side of the text based on a ruby attribute value. In the second mode, display control unit 106C refers to text data 103A-1, and causes display 107 to display text without displaying ruby by neglecting the ruby attribute value in text data 103A-1.

As shown in FIGS. 12(A) and 16, when display control unit 106C causes text to be displayed in detailed area X, display control unit 106C causes display 107 to display the text with ruby based on the ruby attribute value included in text data 103A-1. On the other hand, as shown in FIGS. 12(B) and 16, when display control unit 106C causes text to be displayed in preview area Y, display control unit 106C causes display 107 to display the text, neglecting the ruby attribute value in text data 103A-1.

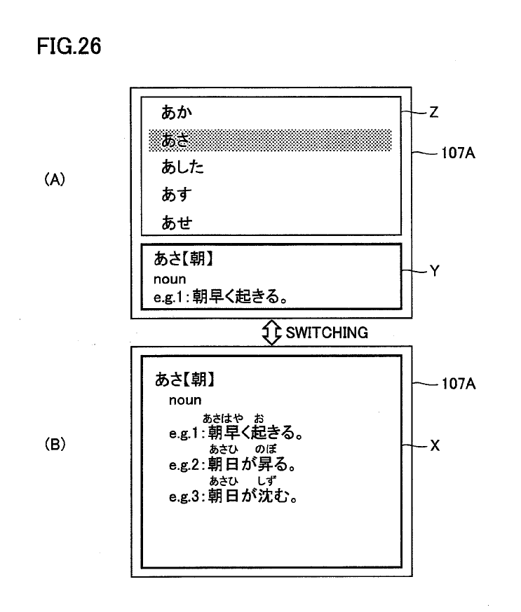

Further, FIG. 26(A) is a fifth schematic diagram showing display 107 in the second mode in accordance with the present embodiment. FIG. 26(B) is a fifth schematic diagram showing display 107 in the first mode in accordance with the present embodiment.

As shown in FIG. 26(B), when display control unit 106C causes text to be displayed in detailed area X, display control unit 106C causes display 107 to display the text with ruby based on the ruby attribute value included in text data 103A-1. That is, display control unit 106C causes display 107 to display ruby on a side of the text (on an upper side of the text in FIG. 26(B)).

On the other hand, as shown in FIG. 26(A), when display control unit 106C causes text to be displayed in preview area Y, display control unit 106C causes only the text to be displayed based on text data 103A-1, without displaying ruby.

Here, the text shown in FIG. 26(A) is displayed based on text data 103A-1 as described below.

<content margin=“1em”> [symbol]
[ [symbol] ]<br/>
noun<br/>
e.g.1:<ruby str= [symbol] > [symbol] </ruby> [symbol] <ruby str= [symbol] > [symbol] </ruby> [symbol] <br/>
e.g.2:<ruby str= [symbol] > [symbol] </ruby> [symbol] <ruby str= [symbol] > [symbol] </ruby> [symbol] <br/>
e.g.3:<ruby str= [symbol] > [symbol] </ruby> [symbol] <ruby
str= [symbol] > [symbol] </ruby> [symbol] <br/>
</content>

Display control unit 106C causes the text to be displayed in detailed area X based on text data 103A-1 as described above. Then, display control unit 106C causes the text to be displayed in preview area Y based on text data 103A-1, neglecting the ruby attribute value.

Alternatively, in the first mode, display control unit 106C refers to text data 103A-1, and causes display 107 to display text and to display ruby on a side of the text based on a ruby attribute value. In the second mode, display control unit 106C refers to text data 103A-1, and causes display 107 to display text and to display ruby at the rear of or in front of the text in an array direction thereof based on the ruby attribute value. That is, display control unit 106C causes display 107 to display ruby in the same line as the associated text. This can prevent an increase in a margin due to ruby within preview area Y.

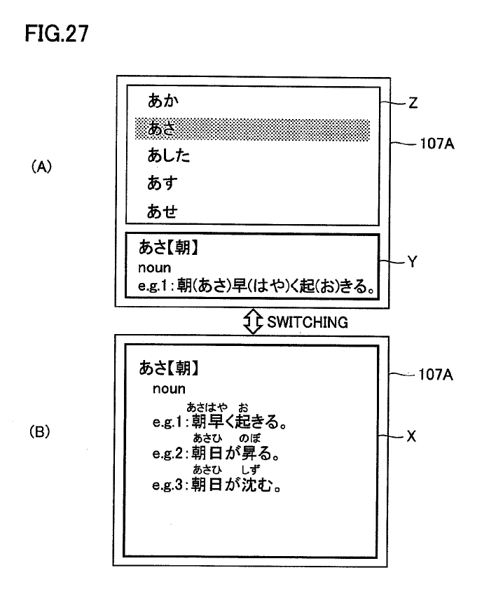

FIG. 27(A) is a sixth schematic diagram showing display 107 in the second mode in accordance with the present embodiment. FIG. 27(B) is a sixth schematic diagram showing display 107 in the first mode in accordance with the present embodiment.

On the other hand, as shown in FIG. 27(B), when display control unit 106C causes text to be displayed in detailed area X, display control unit 106C causes the text to be displayed based on the ruby attribute value included in text data 103A-1. Then, display control unit 106C causes display 107 to display ruby on a side of the associated text (on an upper side in FIG. 27(B)).

On the other hand, as shown in FIG. 27(A), when display control unit 106C causes text to be displayed in preview area Y, display control unit 106C causes display 107 to display ruby at the rear of or in front of the associated text (on a right side or on a left side in FIG. 27(A)).

Since this can increase the number of lines that can be displayed in preview area Y, this exhibits an effect that the amount of displayable information can be comprehensively increased when the number of rubys is small.

Since the text shown in FIG. 27 is displayed based on text data identical to text data 103A-1 in accordance with FIG. 26, the description thereof will not be repeated here.

In the first mode, display control unit 106C causes display 107 to display text and an image based on text data 103A-1 and image data 103E. In the second mode, display control unit 106C causes display 107 to display only text based on text data 103A-1 without displaying an image by neglecting designation of image data 103E in text data 103A-1.

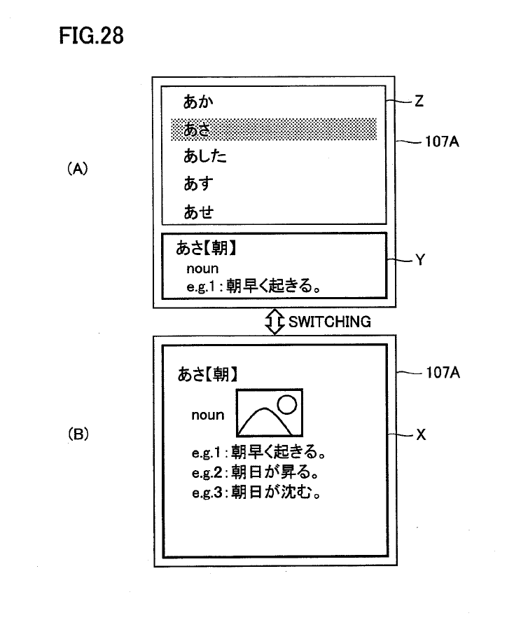

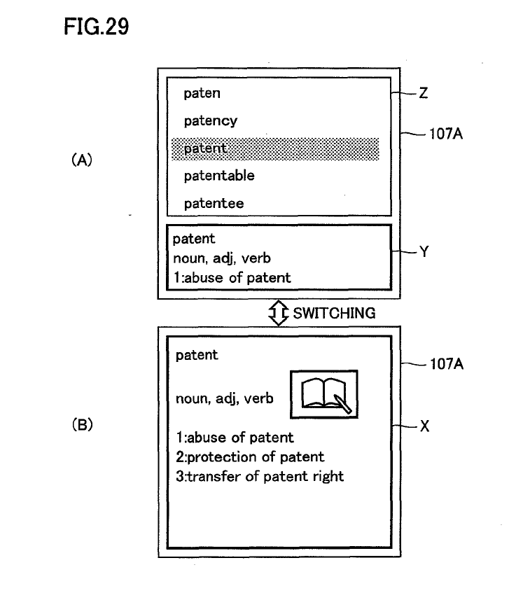

FIG. 28(A) is a seventh schematic diagram showing display 107 for the first language in the second mode in accordance with the present embodiment. FIG. 28(B) is a seventh schematic diagram showing display 107 for the first language in the first mode in accordance with the present embodiment. FIG. 29(A) is a seventh schematic diagram showing display 107 for the second language in the second mode in accordance with the present embodiment. FIG. 29(B) is a seventh schematic diagram showing display 107 for the second language in the first mode in accordance with the present embodiment.

As shown in FIGS. 28(B) and 29(B), when display control unit 106C causes text to be displayed in detailed area X, display control unit 106C reads image data 103E referred to in text data 103A-1, and causes display 107 to display an image and the text. On the other hand, as shown in FIGS. 28(A) and 29(A), when display control unit 106C causes text to be displayed in preview area Y, display control unit 106C causes only the text to be displayed based on text data 103A-1 without displaying an image.

Here, the text shown in FIG. 28 is displayed based on text data 103A-1 as described below.

<content margin=“1em”> [symbol]
[ [symbol] ]<br/>
noun<image align=“right” src=“MorningSun.jpg”/><br/>
e.g.1: [symbol] <br/>
e.g.2: [symbol] <br/>
e.g.3: [symbol] <br/>
</content>

For reference, the text shown in FIG. 29 is displayed based on text data 103A-1 as described below.

<content margin=“1em”>
patent<br/>
noun, adj, verb<image align=“right” src=“Patent.jpg”/><br/>
1:abuse of patent<br/>
2:protection of patent<br/>
3:transfer of patent right<br/>
</content>

As shown in FIGS. 28(B) and 29(B), display control unit 106C causes an image to be pasted in detailed area X based on text data 103A-1 as described above. As shown in FIGS. 28(A) and 29(A), display control unit 106C causes the text to be displayed in preview area Y based on text data 103A-1, neglecting designation to paste an image.

An image occupies a large area in preview area Y although it is often supplementary information. Therefore, there is exhibited an effect that the amount of information displayed in preview area Y can be comprehensively increased by displaying more text instead of displaying an image.

Alternatively, in the first mode, display control unit 106C causes display 107 to display text and an image based on text data 103A-1 and image data 103E. On the other hand, in the second mode, display control unit 106C causes display 107 to display text and a reduced image based on text data 103A-1 and image data 103E.

In this case, display control unit 106C reads image data 103E from storage medium 103S, and generates thumbnail image data based on image data 103E. Then, display control unit 106C causes display 107 unit to display a thumbnail image based on the thumbnail image data.

Since a rough content of an image can be recognized even though the image is reduced, there is obtained an effect that more text can be displayed in preview area Y without reducing the amount of information obtained from the image.

Further, in the first mode, display control unit 106C refers to text data 103A-1, and causes display 107 to display associated text while changing its display manner based on a change attribute value. In the second mode, display control unit 106C refers to text data 103A-1, and causes display 107 not to display associated text by neglecting the change attribute value in text data 103A-1.

As shown in FIG. 12(A), when display control unit 106C causes text to be displayed in detailed area X, display control unit 106C causes the text to be displayed such that the text is gradually temporally shifted from right to left, based on the change attribute value included in text data 103A-1. Further, when display control unit 106C causes text to be displayed in detailed area X, display control unit 106C may cause the text to be displayed in a flashing manner or with a character color and a background color being inverted, based on the change attribute value included in text data 103A-1.

On the other hand, as shown in FIG. 12(B), when display control unit 106C causes text to be displayed in preview area Y, display control unit 106C causes the associated text not to be displayed based on text data 103A-1.

Alternatively, in the first mode, display control unit 106C refers to text data 103A-1, and causes display 107 to display associated text while changing its display manner based on a change attribute value. On the other hand, in the second mode, display control unit 106C refers to text data 103A-1, and causes display 107 to display associated text without changing it by neglecting the change attribute value in text data 103A-1. For example, display control unit 106C causes display 107 to display associated text in a stopped manner, as in a display manner of other text.

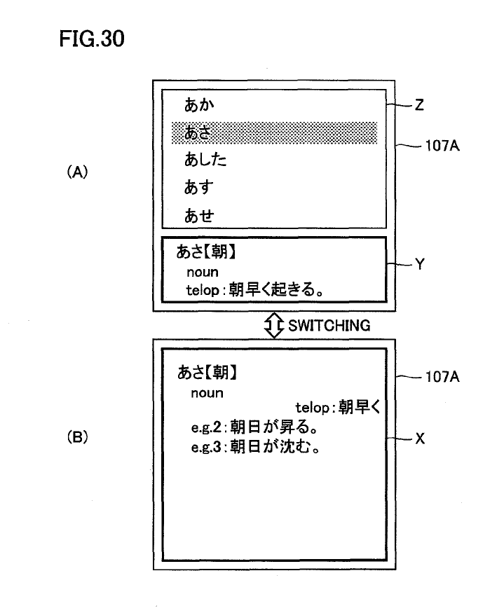

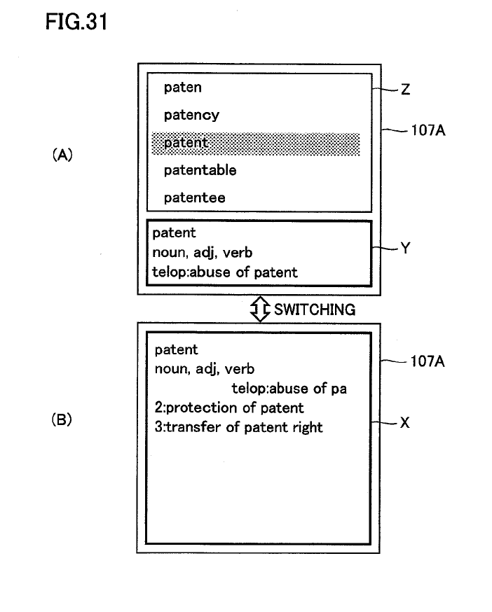

FIG. 30(A) is an eighth schematic diagram showing display 107 for the first language in the second mode in accordance with the present embodiment. FIG. 30(B) is an eighth schematic diagram showing display 107 for the first language in the first mode in accordance with the present embodiment. FIG. 31(A) is an eighth schematic diagram showing display 107 for the second language in the second mode in accordance with the present embodiment. FIG. 31(B) is an eighth schematic diagram showing display 107 for the second language in the first mode in accordance with the present embodiment.

As shown in FIGS. 30(B) and 31(B), when display control unit 106C causes text to be displayed in detailed area X, display control unit 106C causes display 107 to display the text to be shifted based on the change attribute value in text data 103A-1. On the other hand, as shown in FIGS. 30(A) and 31(A), when display control unit 106C causes text to be displayed in preview area Y, display control unit 106C causes the text to be displayed based on text data 103A-1, in a stopped manner as with other text by neglecting the change attribute value.

Since it is difficult to show a manner in which text is changing, FIGS. 30(B) and 31(B) show display 107 at a moment.

Here, the text shown in FIG. 30 is displayed based on text data 103A-1 as described below.

<content margin=“1em”> [symbol]
[ [symbol] ]<br/>
noun<br/>
<telop> [symbol] [symbol] <br/></telop>
e.g.2: [symbol] <br/>
e.g.3: [symbol] <br/>
</content>

For reference, the text shown in FIG. 31 is displayed based on text data 103A-1 as described below.

<content margin=“1em”>
patent<br/>
noun, adj, verb<br/>
<telop>telop:abuse of patent<br/></telop>
2:protection of patent<br/>
3:transfer of patent right<br/>
</content>

As shown in FIGS. 30(B) and 31(B), display control unit 106C causes the text to be dynamically displayed in detailed area X based on text data 103A-1 as described above. As shown in FIGS. 30(A) and 31(A), display control unit 106C causes the text to be statistically displayed in preview area Y based on text data 103A-1, neglecting designation to dynamically display the text, that is, a <telop> tag.

Further, in the first mode, display control unit 106C refers to text data 103A-1, and causes display 107 to selectably display associated text in a display manner different from that of other text, based on a link attribute. In the second mode, display control unit 106C refers to text data 103A-1, and causes display 107 to unselectably display associated text in a display manner identical to that of other text, by neglecting the link attribute in text data 103A-1.

As shown in FIG. 12(A), when display control unit 106C causes text to be displayed in detailed area X, display control unit 106C causes the text to be displayed with an underline or with a character color and a background color being inverted, based on the link attribute included in text data 103A-1. On the other hand, as shown in FIG. 12(B), when display control unit 106C causes text to be displayed in preview area Y, display control unit 106C causes associated text to be displayed in a display manner identical to that of other text, based on text data 103A-1.

Further, in the first mode, display control unit 106C refers to text data 103A-1, and sets a background color of associated text to display 107 based on the third display attribute value included in the second display attribute group. On the other hand, in the second mode, display control unit 106C refers to text data 103A-1, and sets the predetermined background color based on the predetermined fourth display attribute value or by neglecting the third display attribute value in text data 103A-1.

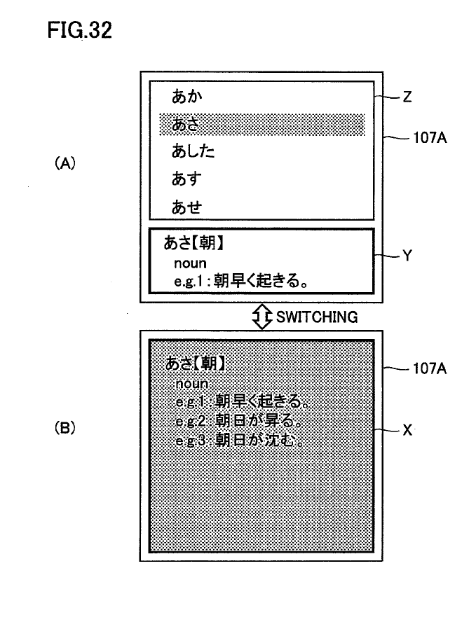

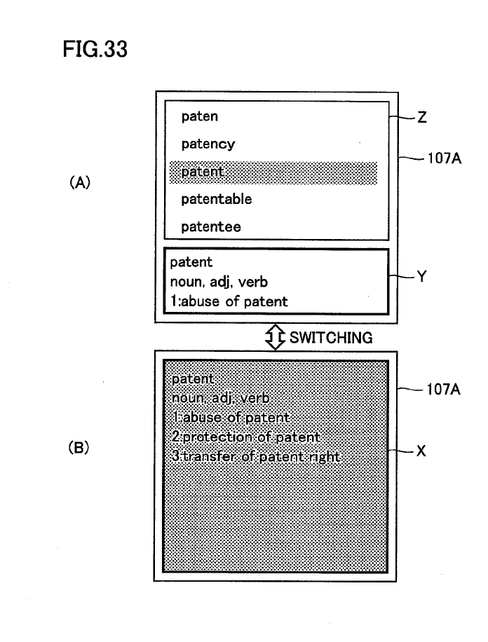

FIG. 32(A) is a ninth schematic diagram showing display 107 for the first language in the second mode in accordance with the present embodiment. FIG. 32(B) is a ninth schematic diagram showing display 107 for the first language in the first mode in accordance with the present embodiment. FIG. 33(A) is a ninth schematic diagram showing display 107 for the second language in the second mode in accordance with the present embodiment. FIG. 33(B) is a ninth schematic diagram showing display 107 for the second language in the first mode in accordance with the present embodiment.

As shown in FIGS. 32(B) and 33(B), when display control unit 106C causes text to be displayed in detailed area X, display control unit 106C colors a background of the text or colors the entire detailed area X, based on the third attribute value included in text data 103A-1. On the other hand, as shown in FIGS. 32(A) and 33(A), when display control unit 106C causes text to be displayed in preview area Y, display control unit 106C refers to text data 103A-1, and causes display 107 to display the text based on the fourth attribute value, without coloring a background of preview area Y by, for example, neglecting the third attribute value.

Here, the text shown in FIG. 32 is displayed based on text data 103A-1 as described below.

<content sound=“morning.wav” bgColor=“blue” bgImage=“morning.jpg”
margin=“1em”> [symbol]
[ [symbol] ]<br/>
noun<br/>
e.g.1: [symbol] <br/>
e.g.2: [symbol] <br/>
e.g.3: [symbol] <br/>
</content>

As shown in FIG. 32(B), display control unit 106C provides a background color to detailed area X based on text data 103A-1 as described above. As shown in FIG. 32(A), display control unit 106C causes the text to be displayed in preview area Y based on text data 103A-1, neglecting designation to reproduce audio, that is, a tag <content sound=“morning.wav”>, designation of a background color, that is, a tag <bgColor=“blue”>, and designation of a background image, that is, a tag <bgImage=“morning.jpg”>.

For reference, the text shown in FIG. 33 is displayed based on text data 103A-1 as described below.

<content sound=“patent.wav” bgColor=“blue” bgImage=“patent.jpg”
margin=“1em”>
patent<br/>
noun, adj, verb<br/>
1:abuse of patent<br/>
2:protection of patent<br/>
3:transfer of patent right<br/>
</content>

As shown in FIG. 33(B), display control unit 106C provides a background color to detailed area X based on text data 103A-1 as described above. As shown in FIG. 33(A), display control unit 106C causes the text to be displayed in preview area Y based on text data 103A-1, neglecting designation to reproduce audio, that is, a tag <content sound=“patent.wav”>, designation of a background color, that is, a tag <bgColor=“blue”>, and designation of a background image, that is, a tag <bgImage=“patent.jpg”>.

<Text Display Processing>

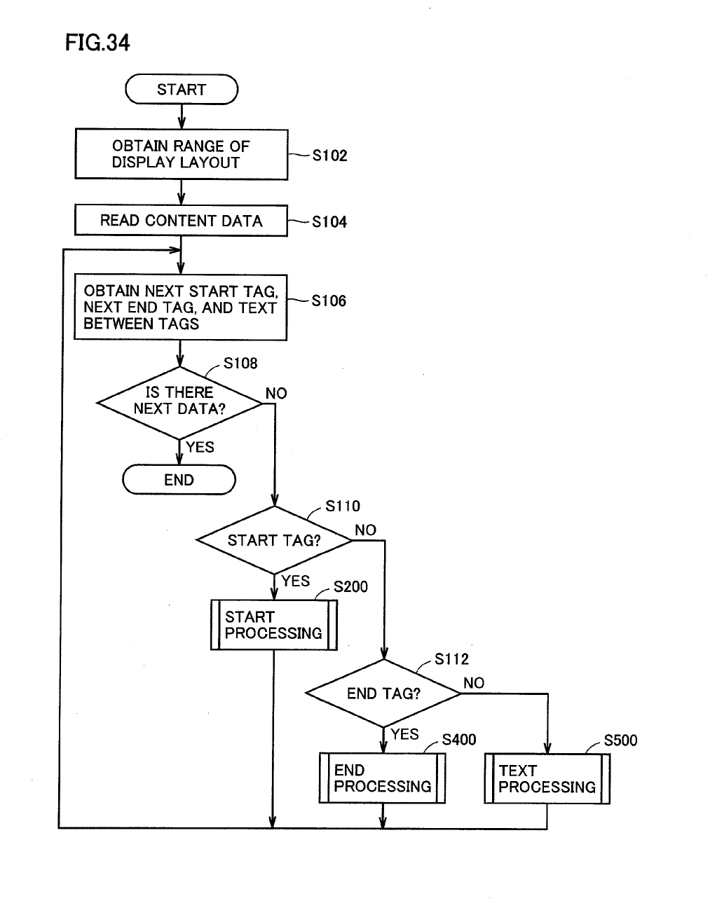

Next, a processing procedure for text display processing (text layout processing) in electronic dictionary 100 (mobile phone 200) in accordance with the present embodiment will be described. FIG. 34 is a flowchart illustrating a processing procedure for text display processing in electronic dictionary 100 (mobile phone 200) in accordance with the present embodiment. It is to be noted that the processing procedure described below is a mere example of text display processing, and the same processing can be implemented by a processing procedure other than that.

As shown in FIG. 34, CPU 106 obtains a range of display layout in which text should be displayed (preview area Y or detailed area X) (step S102). CPU 106 reads content data (text data 103A-1) corresponding to a word being selected or a decided word from storage medium 103S (step S104). CPU 106 extracts a next start tag, a next end tag, and text between the tags (step S106).

CPU 106 may perform processing described below after producing tree-like data by reading all tags (a DOM (Document Object Model) format). Hereinafter, a start tag, an end tag, and text between the tags as targets will be collectively referred to as target data.

Then, CPU 106 determines whether or not there is next target data within text data 103A-1 (step S108). If there is no next target data within text data 103A-1 (NO in step S108), CPU 106 terminates the text display processing.

On the other hand, if there is next target data within text data 103A-1 (YES in step S108), CPU 106 determines whether or not the target data is a start tag (step S110). If the target data is a start tag (YES in step S110), CPU 106 performs start processing (step S200). The start processing (step S200) will be described later.

On the other hand, if the target data is not a start tag (NO in step S110), CPU 106 determines whether or not the target data is an end tag (step S112). If the target data is an end tag (YES in step S112), CPU 106 performs end processing (step S400). The end processing (step S400) will be described later.

On the other hand, if the target data is not an end tag (NO in step S112), CPU 106 performs text processing (step S500). The text processing (step S500) will be described later.

(Start Processing)

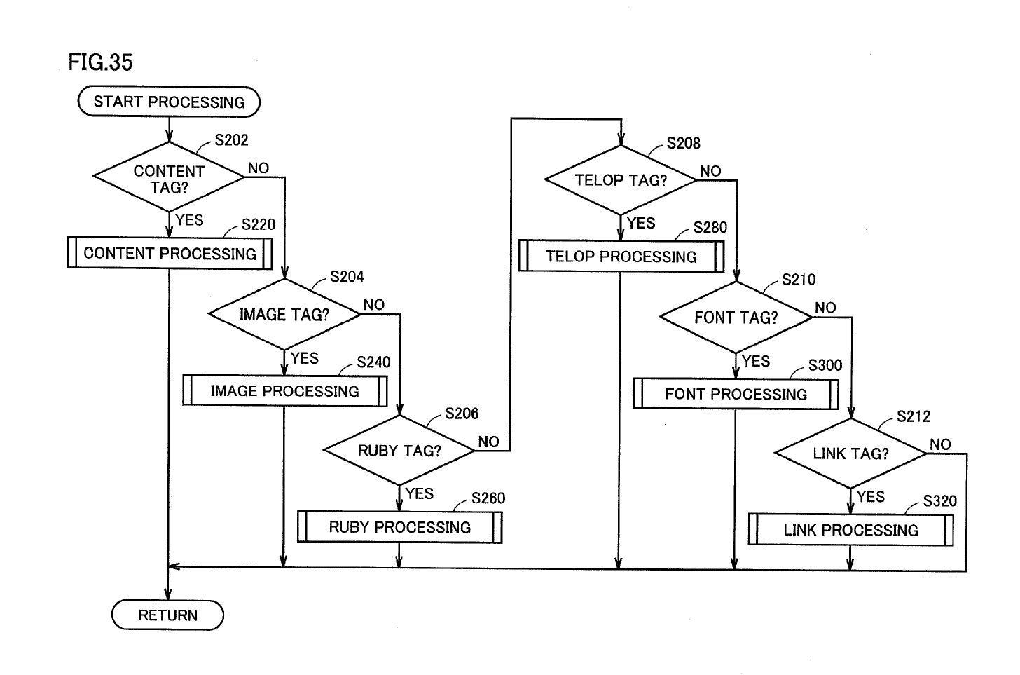

Next, a processing procedure for the start processing (step S200) in electronic dictionary 100 (mobile phone 200) in accordance with the present embodiment will be described. FIG. 35 is a flowchart illustrating a processing procedure for the start processing (step S200) in electronic dictionary 100 (mobile phone 200) in accordance with the present embodiment.

As shown in FIG. 35, CPU 106 determines whether or not the start tag is a content tag (step S202). That is, CPU 106 determines whether or not the start tag includes designation of a background color, a margin, a line space, and a character space. If the start tag is a content tag (YES in step S202), CPU 106 performs content processing (step S220), and then repeats the processing from step S106. The content processing (step S220) will be described later.

On the other hand, if the start tag is not a content tag (NO in step S202), CPU 106 determines whether or not the start tag is an image view tag (step S204). That is, CPU 106 determines whether or not the start tag includes designation of image data. If the start tag is an image view tag (YES in step S204), CPU 106 performs image processing (step S240), and then repeats the processing from step S106. The image processing (step S240) will be described later.

On the other hand, if the start tag is not an image view tag (YES in step S204), CPU 106 determines whether or not the start tag is a ruby tag (step S206). That is, CPU 106 determines whether or not the start tag includes a ruby attribute. If the start tag is a ruby tag (YES in step S206), CPU 106 performs ruby processing (step S260), and then repeats the processing from step S106. The ruby processing (step S260) will be described later.

On the other hand, if the start tag is not a ruby tag (NO in step S206), CPU 106 determines whether or not the start tag is a telop tag (step S208). That is, CPU 106 determines whether or not the start tag includes a change attribute. If the start tag is a telop tag (YES in step S208), CPU 106 performs telop processing (step S280), and then repeats the processing from step S106. The telop processing (step S280) will be described later.

On the other hand, if the start tag is not a telop tag (NO in step S208), CPU 106 determines whether or not the start tag is a font tag (step S210). That is, CPU 106 determines whether or not the start tag includes designation of a font size. If the start tag is a font tag (YES in step S210), CPU 106 performs font processing (step S300), and then repeats the processing from step S106. The font processing (step S300) will be described later.

On the other hand, if the start tag is not a font tag (NO in step S210), CPU 106 determines whether or not the start tag is a link tag (step S212). CPU 106 determines whether or not the start tag includes a link attribute. If the start tag is a link tag (YES in step S212), CPU 106 performs link processing (320), and then repeats the processing from step S106. The link processing (step S320) will be described later.

On the other hand, if the start tag is not a link tag (NO in step S212), CPU 106 terminates the start processing (step S200), and then repeats the processing from step S106.

(Content Processing)

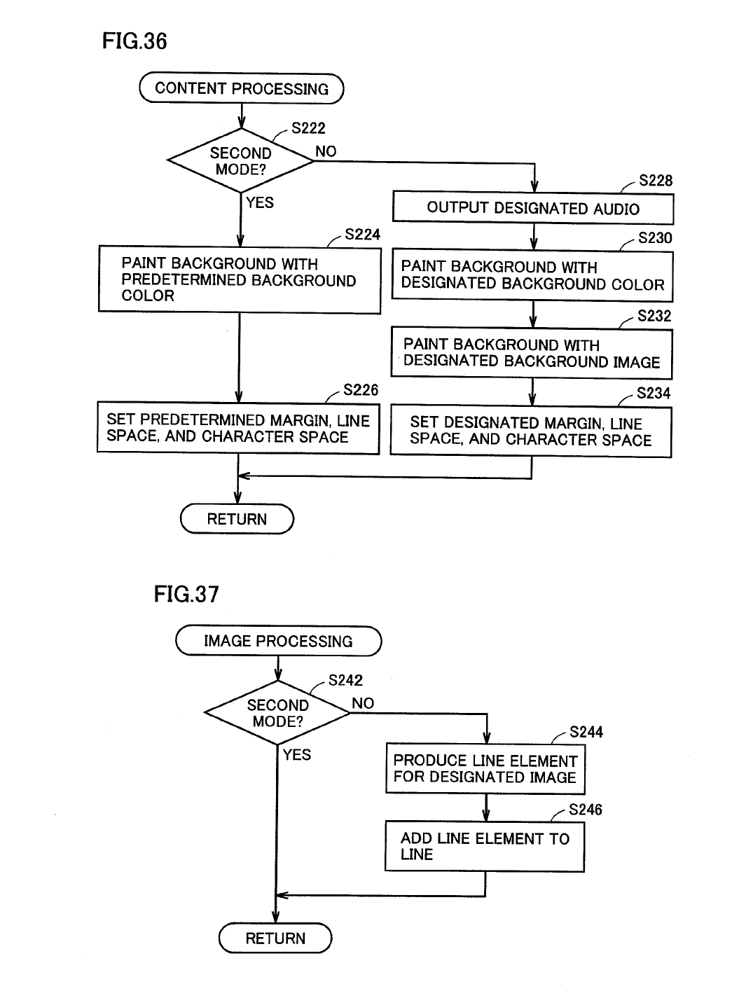

Next, a processing procedure for the content processing (step S220) in electronic dictionary 100 (mobile phone 200) in accordance with the present embodiment will be described. FIG. 36 is a flowchart illustrating a processing procedure for the content processing (step S220) in electronic dictionary 100 (mobile phone 200) in accordance with the present embodiment.

As shown in FIG. 36, CPU 106 determines whether or not a display state is the second mode (step S222). Here, the second mode refers to a state where words are selectably displayed in list area Z of display 107, and a portion of an explanatory sentence for a word being selected is displayed in preview area Y. In addition, the first mode refers to a state where an explanatory sentence for a word selected from among words displayed as a list is displayed in detailed area X of display 107.

If the display state is the second mode (YES in step S222), CPU 106 causes display 107 to apply a predetermined background color (step S224). CPU 106 sets predetermined margin, line space, and character space (step S226). More specifically, CPU 106 stores data of the predetermined margin, line space, and character space in main storage medium 103 (203). Alternatively, CPU 106 turns on flags designating the predetermined margin, line space, and character space in main storage medium 103.

Thereafter, CPU 106 terminates the content processing (step S220), and then terminates the start processing (step S200).

On the other hand, if the display state is not the second mode (NO in step S222), that is, if the display state is the first mode, CPU 106 reads audio data 103F corresponding to text data 103A-1 from storage medium 103S, and outputs designated audio through speaker 109 (209) based on audio data 103F (step S228).

CPU 106 causes display 107 to apply a background color designated in text data 103A-1 (step S230). CPU 106 also causes display 107 to apply a background moving image designated in text data 103A-1 (step S232). CPU 106 sets a margin, a line space, and a character space designated in text data 103A-1 (step S234). More specifically, CPU 106 stores data of the margin, the line space, and the character space designated in text data 103A-1 in main storage medium 103.

Thereafter, CPU 106 terminates the content processing (step S220), and then terminates the start processing (step S200).

(Image Processing)

Next, a processing procedure for the image processing (step S240) in electronic dictionary 100 (mobile phone 200) in accordance with the present embodiment will be described. FIG. 37 is a flowchart illustrating a processing procedure for the image processing (step S240) in electronic dictionary 100 (mobile phone 200) in accordance with the present embodiment.

As shown in FIG. 37, CPU 106 determines whether or not the display state is the second mode (step S242). If the display state is the second mode (YES in step S242), CPU 106 terminates the image processing (step S240), and then terminates the start processing (step S200).

On the other hand, if the display state is not the second mode (NO in step S242), that is, if the display state is the first mode, CPU 106 reads image data 103E designated in text data 103A-1 from storage medium 103S, and produces a line element corresponding to image data 103E (step S244). CPU 106 adds the line element to a line in line database 103C (step S246).

Thereafter, CPU 106 terminates the image processing (step S240), and then terminates the start processing (step S200).

(Ruby Processing)

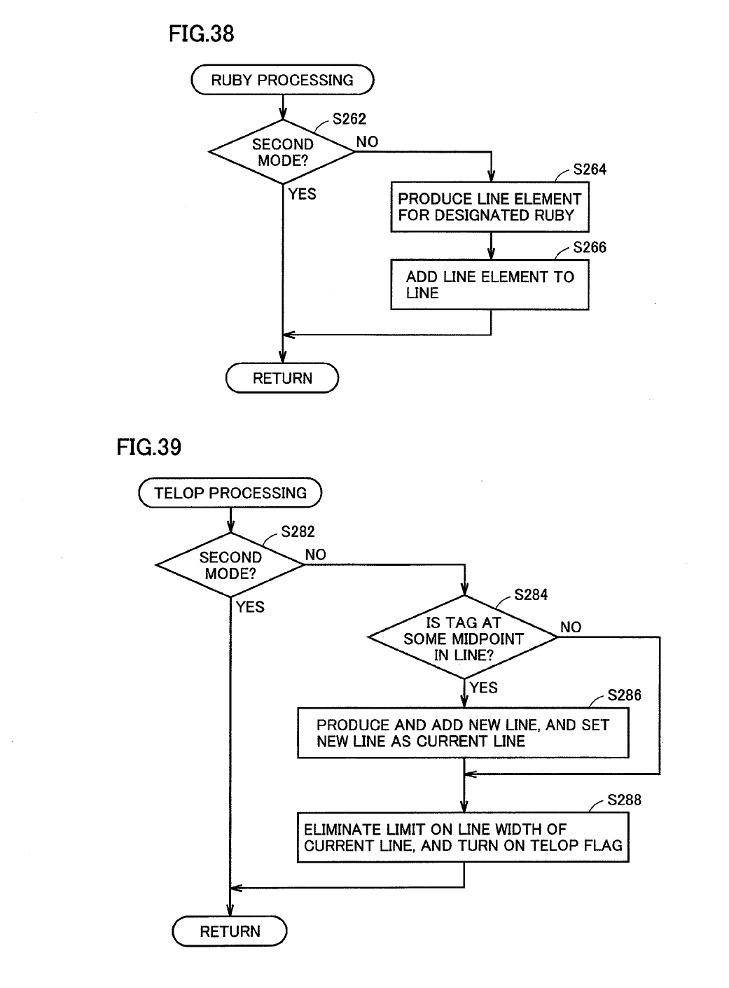

Next, a processing procedure for the ruby processing (step S260) in electronic dictionary 100 (mobile phone 200) in accordance with the present embodiment will be described. FIG. 38 is a flowchart illustrating a processing procedure for the ruby processing (step S260) in electronic dictionary 100 (mobile phone 200) in accordance with the present embodiment. As shown in FIG. 38, CPU 106 determines whether or not the display state is the second mode (step S262). If the display state is the second mode (YES in step S262), CPU 106 terminates the ruby processing (step S260), and then terminates the start processing (step S200).

On the other hand, if the display state is not the second mode (NO in step S262), that is, if the display state is the first mode, CPU 106 produces a line element corresponding to a designated ruby attribute (step S264). CPU 106 adds the line element to a line in line database 103C (step S266).

Thereafter, CPU 106 terminates the image processing (step S260), and then terminates the start processing (step S200).

(Telop Processing)

Next, a processing procedure for the telop processing (step S280) in electronic dictionary 100 (mobile phone 200) in accordance with the present embodiment will be described. FIG. 39 is a flowchart illustrating a processing procedure for the telop processing (step S280) in electronic dictionary 100 (mobile phone 200) in accordance with the present embodiment.

As shown in FIG. 39, CPU 106 determines whether or not the display state is the second mode (step S282). If the display state is the second mode (YES in step S282), CPU 106 terminates the telop processing (step S280), and then terminates the start processing (step S200).

On the other hand, if the display state is not the second mode (NO in step S282), CPU 106 determines whether or not a target start tag is at some midpoint in a line (step S284). If the start tag is at some midpoint in a line (YES in step S284), CPU 106 produces a new line, and sets the new line as a current line (step S286). Then, CPU 106 eliminates (neglects) a limit on the line width of the current line, and turns on a telop flag in main storage medium 103 (step S288).

On the other hand, if the start tag is not at some midpoint in a line (NO in step S284), CPU 106 eliminates (neglects) a limit on the line width of the current line, and turns on the telop flag in main storage medium 103 (step S288).

Thereafter, CPU 106 terminates the telop processing (step S280), and then terminates the start processing (step S200).

(Font Processing)

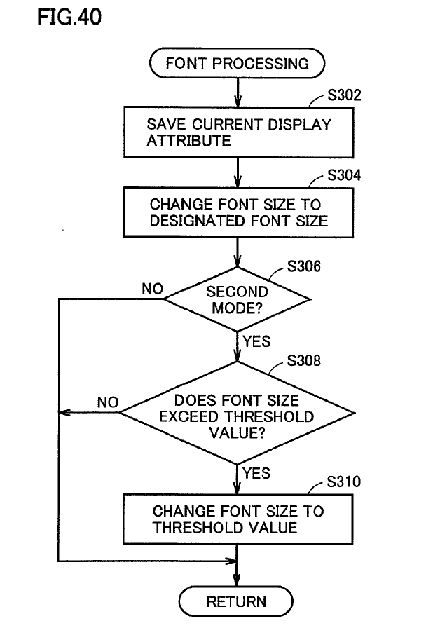

Next, a processing procedure for the font processing (step S300) in electronic dictionary 100 (mobile phone 200) in accordance with the present embodiment will be described. FIG. 40 is a flowchart illustrating a processing procedure for the font processing (step S300) in electronic dictionary 100 (mobile phone 200) in accordance with the present embodiment.

As shown in FIG. 40, CPU 106 stores a display attribute included in the start tag in main storage medium 103 (step S302). CPU 106 changes a font size of target text to a font size designated in text data 103A-1 (step S304).

Then, CPU 106 determines whether or not the display state is the second mode (step S306). If the display state is not the second mode (NO in step S306), CPU 106 terminates the font processing (step S300), and then terminates the start processing (step S200).

On the other hand, if the display state is the second mode (YES in step S306), that is, if the display state is the first mode, CPU 106 determines whether or not the font size designated in text data 103A-1 exceeds a threshold value (step S308). If the font size designated in text data 103A-1 does not exceed the threshold value (NO in step S308), CPU 106 terminates the font processing (step S300), and then terminates the start processing (step S200).

On the other hand, if the font size designated in text data 103A-1 exceeds the threshold value (YES in step S308), CPU 106 changes the font size of the target text to the threshold value (step S310).

Then, CPU 106 terminates the font processing (step S300), and then terminates the start processing (step S200).

(Link Processing)

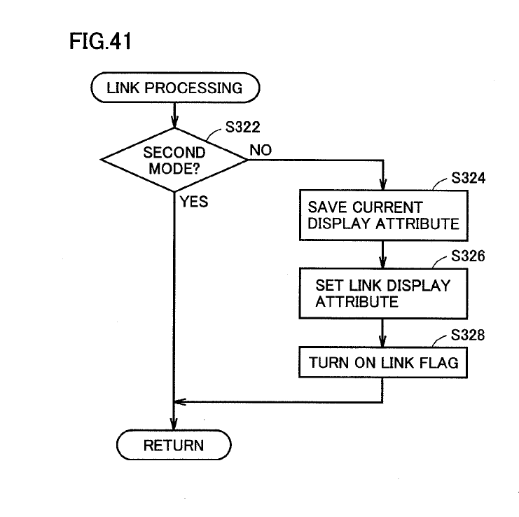

Next, a processing procedure for the link processing (step S320) in electronic dictionary 100 (mobile phone 200) in accordance with the present embodiment will be described. FIG. 41 is a flowchart illustrating a processing procedure for the link processing (step S320) in electronic dictionary 100 (mobile phone 200) in accordance with the present embodiment.

As shown in FIG. 41, CPU 106 determines whether or not the display state is the second mode (step S322). If the display state is the second mode (YES in step S322), CPU 106 terminates the link processing (step S320), and then terminates the start processing (step S200).

On the other hand, if the display state is not the second mode (NO in step S322), that is, if the display state is the first mode, CPU 106 stores a display attribute included in the start tag in main storage medium 103 (step S324). CPU 106 sets a link attribute (step S326). CPU 106 turns on a link flag for target text in main storage medium 103 (step S328).

Thereafter, CPU 106 terminates the link processing (step S320), and then terminates the start processing (step S200).

(End Processing)

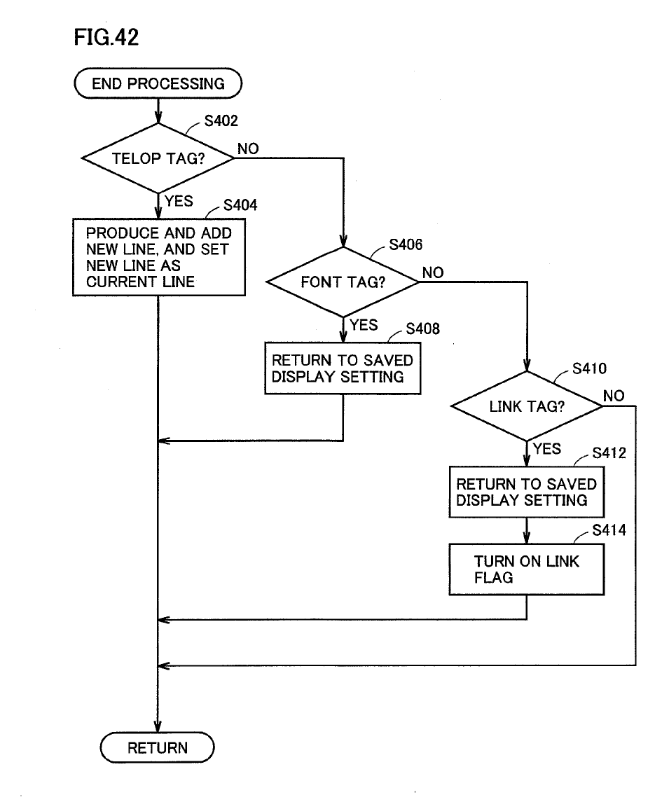

Next, a processing procedure for the end processing (step S400) in electronic dictionary 100 (mobile phone 200) in accordance with the present embodiment will be described. FIG. 42 is a flowchart illustrating a processing procedure for the end processing (step S400) in electronic dictionary 100 (mobile phone 200) in accordance with the present embodiment.

As shown in FIG. 42, CPU 106 determines whether or not the end tag is a telop tag (step S402). If the end tag is a telop tag (YES in step S402), CPU 106 produces a new line, and sets the new line as a current line (step S404).

On the other hand, if the end tag is not a telop tag (NO in step S402), CPU 106 determines whether or not the end tag is a font tag (step S406). If the end tag is a font tag (YES in step S406), CPU 106 returns a display attribute stored in main storage medium 103 to an initial value (step S408).

On the other hand, if the end tag is not a font tag (NO in step S406), CPU 106 determines whether or not the end tag is a link tag (step S410). If the end tag is a link tag (YES in step S410), CPU 106 returns a display attribute stored in main storage medium 103 to an initial value (step S412). Then, CPU 106 turns on the link flag in main storage medium 103 (step S414).

On the other hand, if the end tag is not a link tag (NO in step S410), CPU 106 terminates the end processing (step S400), and then repeats the processing from step S106.

(Text Processing)

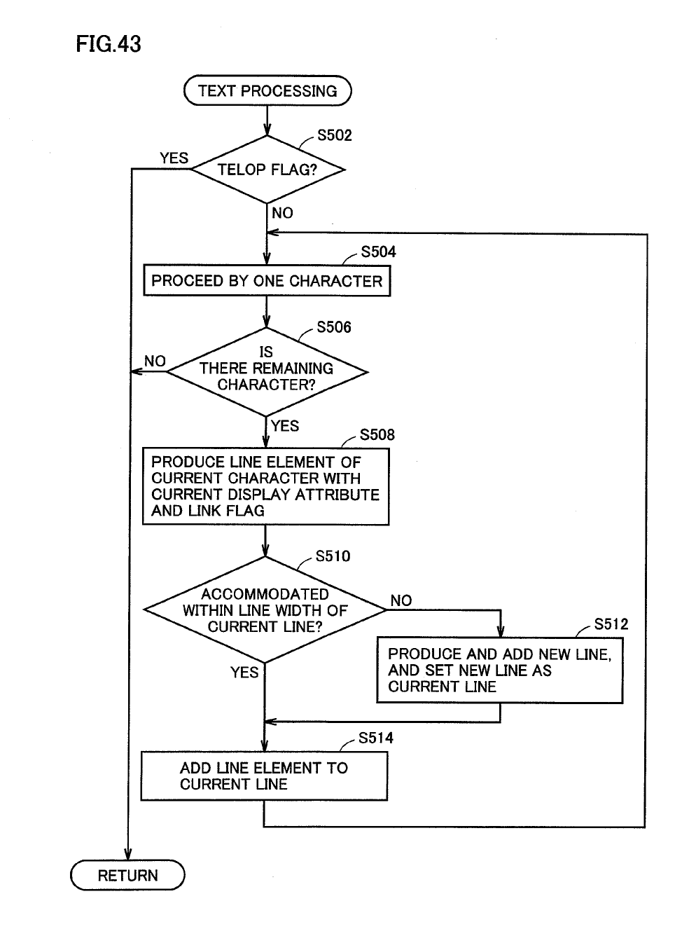

Next, a processing procedure for the text processing (step S500) in electronic dictionary 100 (mobile phone 200) in accordance with the present embodiment will be described. FIG. 43 is a flowchart illustrating a processing procedure for the text processing (step S500) in electronic dictionary 100 (mobile phone 200) in accordance with the present embodiment.

As shown in FIG. 43, CPU 106 determines whether or not the telop flag in main storage medium 103 is on (step S502). If the telop flag is on (YES in step S502), CPU 106 terminates the text processing (step S500), and then repeats the processing from step S106.

On the other hand, if the telop flag is not on (NO in step S502), CPU 106 proceeds to a next character (text) not analyzed yet (step S504). That is, CPU 106 sets the next character as a current character. Here, CPU 106 determines whether or not there is a next character not analyzed yet (a remaining character) (step S506). That is, CPU 106 determines whether or not next text is a code indicating an end tag. If there is no next character (remaining character) (NO in step S506), CPU 106 terminates the text processing (step S500), and then repeats the processing from step S106.

On the other hand, if there is a next character not analyzed yet (a remaining character) (YES in step S506), CPU 106 produces a line element of the current character based on a display attribute (ON/OFF of the flag) stored in main storage medium 103 (step S508). CPU 106 determines whether or not the current character is accommodated within the line width of the current line (step S510). It is preferable that CPU 106 already obtains the line width of the current line in step S102. If the current character is accommodated within the line width of the current line (YES in step S510), CPU 106 adds the line element to the current line (step S512), and then repeats the processing from step S504.

On the other hand, if the current character is not accommodated within the line width of the current line (NO in step S510), CPU 106 produces a new line, and sets the new line as a current line (step S512). Thereafter, CPU 106 adds the line element to the current line (step S512), and then repeats the processing from step 5504.

<Modification of Text Display Processing>

In the present embodiment, the information processing device causes an explanatory sentence to be displayed in detailed area X and preview area Y while reading text data 103A-1 from above in order. However, for example, when CPU 106, that is, display control unit 106C, causes text to be displayed in preview area Y, it may refer to text data 103A-1 and may generate text data 103A-2 for preview area Y based on a predetermined display attribute. Then, display control unit 106C may cause display 107 to display the text based on text data 103A-2.

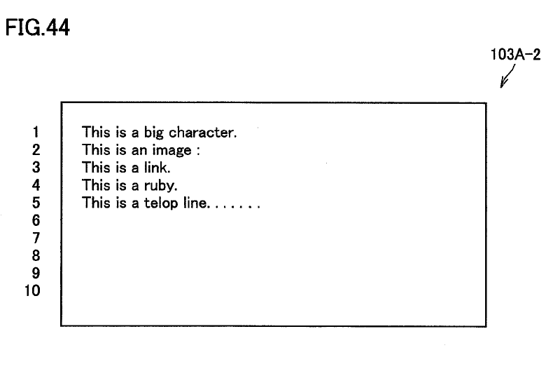

FIG. 44 is a schematic diagram showing text data 103A-2 for preview area Y for displaying a sentence for explaining one word. As shown in FIG. 44, display control unit 106C produces text data 103A-2 in which a display attribute set in text data 103A-1 is changed to a predetermined display attribute. That is, display control unit 106C produces new text data 103A-2, neglecting the display attribute set in text data 103A-1. Then, display control unit 106C causes display 107 to display text based on text data 103A-2.

In other words, FIG. 44 shows a source code of displayed text in the case where display control unit 106C causes display 107 to display the text by neglecting the display attribute in text data 103A-1.

### Other Embodiments

A program in accordance with the present invention may call up necessary modules in a predetermined array at predetermined timing from among program modules provided as a portion of an operation system (OS) of a computer, and may cause processing to be executed. In that case, the modules are not included in the program itself, and the processing is executed in cooperation with the OS. A program not including such modules can also be included in the program in accordance with the present invention.

Further, the program in accordance with the present invention may be provided by being incorporated into a portion of another program. In that case as well, modules included in the other program are not included in the program itself, and processing is executed in cooperation with the other program. A program incorporated into another program as described above can also be included in the program in accordance with the present invention.

A program product to be provided is installed in a program storage unit such as a memory and a hard disk, and then executed by a CPU. The program product includes a program itself and a storage medium storing the program.

Further, some or all of the functions implemented by the program in accordance with the present invention (for example, the function block shown in FIG. 15) may be configured by exclusive hardware.

It should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

1-17. (canceled)

18. An information processing device, comprising:
a display;
and
a processor for reading data for displaying text from a memory,
wherein said data includes a plurality of characters and a relationship of association between a character string fanned of at least one said character and a display attribute value,
if a first mode is designated, said processor causes each of at least one said character string included in said data to be displayed within a first display area of said display in a display manner in accordance with the associated display attribute value, and
if a second mode is designated, said processor causes at least one said character string included in said data to be displayed within a second display area smaller than said first display area of said display in a predetermined display manner.

19. The information processing device according to claim 18, wherein
the display attribute value associated with said character string includes a first display attribute value included in a first display attribute value group,
a display attribute value corresponding to said predetermined display manner includes a second display attribute value included in said first display attribute value group,
said first display attribute value group is a font size group,
said first display attribute value is a font size, and
said second display attribute value is a predetermined font size.

20. The information processing device according to claim 19, wherein
said processor includes a determination unit determining whether or not said first display attribute value is not less than said second display attribute value,
if said first display attribute value is not less than said second display attribute value in said second mode, said processor causes said display to display said character string based on
said second display attribute value, and
if said first display attribute value is less than said second display attribute value in said second mode, said processor causes said display to display said character string based on said first display attribute value.

21. The information processing device according to claim 18, further comprising a manipulation unit receiving first and second instructions for designating a display state by said display,
wherein said processor shifts from said second mode to said first mode in accordance with the first instruction, and shifts from said first mode to said second mode in accordance with the second instruction.

22. The information processing device according to claim 21, wherein
said data includes a plurality of said text and a word corresponding to each text,
in said second mode, said processor causes said display to selectably display a plurality of said words as a list within a third display area, and causes said display to display said text corresponding to said word being selected in said second display area, and
in said second mode, said manipulation unit receives an instruction to decide one word from the plurality of said words displayed as a list on said display as said first instruction.

23. The information processing device according to claim 18, wherein
the display attribute value associated with said character string includes a third display attribute value included in a second display attribute value group,
a display attribute value corresponding to said predetermined display manner includes a fourth display attribute value included in said second display attribute value group,
said second display attribute value group is a color group,
said third display attribute value is a color, and
said fourth display attribute value is a predetermined color.

24. The information processing device according to claim 18, wherein
said data includes line break designation displaying said text with a line break,
in said first mode, said processor refers to said data, and causes said display to display said text with a line break based on said line break designation, and
in said second mode, said processor refers to said data, and causes said display to display said text with no line break.

25. The information processing device according to claim 18, wherein
said memory further stores image data to associate it with said data,
in said first mode, said processor causes said display to display said text and image based on said data and said image data, and
in said second mode, said processor causes said display to display said character string based on said data without displaying said image.

26. The information processing device according to claim 18, wherein
said memory further stores image data to associate it with said data,
in said first mode, said processor causes said display to display said text and image based on said data and said image data, and
in said second mode, said processor causes said display to display said text and said image as reduced based on said data and said image data.

27. The information processing device according to claim 18, wherein
said data includes a character string for which a change attribute value to temporally change the display manner is defined,
in said first mode, said processor refers to said data, and causes said display to display associated said character string while changing the display manner based on said change attribute value, and
in said second mode, said processor does not cause said display to display associated said character string.

28. The information processing device according to claim 18, wherein
said data includes a character string for which a change attribute value to temporally change the display manner is defined,
in said first mode, said processor refers to said data, and causes said display to display associated said character string while changing the display manner based on said change attribute value, and
in said second mode, said processor refers to said data, and causes said display to display associated said character string without changing the display manner.

29. The information processing device according to claim 18, wherein
said data includes a character string for which a link attribute indicating that a link is provided is defined,
in said first mode, said processor refers to said data, and causes said display to selectably display associated said character string in a display manner different from that of other text based on said link attribute, and
in said second mode, said processor refers to said data, and causes said display to unselectably display associated said character string in a display manner identical to that of other text.

30. The information processing device according to claim 29, further comprising search unit referring to said memory and searching for words including an input character string,
wherein, in said second mode, said processor causes said display to selectably display said words as searched for as a list within a third display area.

31. A computer-readable recording medium recording a text display program for causing an information processing device to display a character string,
said information processing device including a display and a processor controlling said information processing device,
said text display program causing said processor to perform the steps of:
reading data including a plurality of character strings with each of which a display attribute value is associated;
causing each of said plurality of character strings included in said data to be displayed within a first display area of said display in a display manner in accordance with the associated display attribute value, if a first mode is designated; and
causing said plurality of character strings included in said data to be displayed within a second display area smaller than said first display area of said display in a predetermined display manner, if a second mode is designated.

32. A text display method in an information processing device, said information processing device including a display and a processor controlling said information processing device, comprising the steps of:
said processor reading data including a plurality of character strings with each of which a display attribute value is associated;
said processor causing each of said plurality of character strings included in said data to be displayed within a first display area of said display in a display manner in accordance with the associated display attribute value, if a first mode is designated; and
said processor causing said plurality of character strings included in said data to be displayed within a second display area smaller than said first display area of said display in a predetermined display manner, if a second mode is designated.
